(19) United States
(12) Patent Application Publication
(10) Pub. No.: US 2026/0170697 A1
(43) Pub. Date: Jun. 18, 2026

(54) METHOD FOR ENCODING/DECODING IMAGE AND RECORDING MEDIUM STORING INSTRUCTIONS FOR EXECUTING THE ENCODING METHOD

(71) Applicant: Electronics and Telecommunications Research Institute, Daejeon (KR)

(72) Inventors: Hong Chang SHIN, Daejeon (KR); Gwangsoon LEE, Daejeon (KR)

(73) Assignee: Electronics and Telecommunications Research Institute, Daejeon (KR)

(21) Appl. No.: 19/183,358

(22) Filed: Apr. 18, 2025

(30) Foreign Application Priority Data
Apr. 18, 2024 (KR) 10-2024-0052294
Apr. 22, 2024 (KR) 10-2024-0053576
Jul. 15, 2024 (KR) 10-2024-0093337
Jul. 16, 2024 (KR) 10-2024-0094043

(51) Int. Cl. G06T 9/00; H04N 19/70

(52) U.S. Cl. CPC G06T 9/001; H04N 19/70

(57) ABSTRACT

An image encoding method according to the present disclosure may include obtaining two-dimensional images of a multi-layer structure by projecting voxels configuring a point cloud onto a two-dimensional plane; and encoding the two-dimensional images of the multi-layer structure. In this case, the two-dimensional images may include as many texture component images as the number of coefficients of the spherical harmonics.

### TECHNICAL FIELD

The present disclosure relates to a method for encoding/decoding an immersive image which supports motion parallax for rotation and translation motions.

### BACKGROUND ART

A virtual reality service is evolving in a direction of providing a service in which a sense of immersion and realism are maximized by generating an omnidirectional image in a form of an actual image or CG (Computer Graphics) and playing it on HMD, a smartphone, etc. Currently, it is known that 6 Degrees of Freedom (DoF) should be supported to play a natural and immersive omnidirectional image through HMD. For a 6DoF image, an image which is free in six directions including (1) left and right rotation, (2) top and bottom rotation, (3) left and right movement, (4) top and bottom movement, etc. should be provided through a HMD screen. But, most of the omnidirectional images based on an actual image support only rotary motion. Accordingly, a study on a field such as acquisition, reproduction technology, etc. of a 6DoF omnidirectional image is actively under way.

### DISCLOSURE

### Technical Problem

The present disclosure is to provide a method for encoding/decoding a voxel in a three-dimensional space.

The present disclosure is to provide a method for encoding/decoding the directional information of a voxel on a three-dimensional space based on images of a multi-layer structure.

The present disclosure is to provide a method for preventing voxels from being lost during the process of being projected onto a two-dimensional plane.

The technical objects to be achieved by the present disclosure are not limited to the above-described technical objects, and other technical objects which are not described herein will be clearly understood by those skilled in the pertinent art from the following description.

### Technical Solution

An image encoding method according to the present disclosure may include obtaining two-dimensional images of a multi-layer structure by projecting voxels configuring a point cloud onto a two-dimensional plane; and encoding the two-dimensional images of the multi-layer structure. In this case, the two-dimensional images may include as many texture component images as the number of coefficients of spherical harmonics.

In an image encoding method according to the present disclosure, information on the coefficients of the current voxel may be included in pixels of a coordinate (hereinafter, referred to as “a corresponding coordinate”) corresponding to a current voxel in the texture component images.

In an image encoding method according to the present disclosure, when the pixel of a coordinate (hereinafter, referred to as “a projection coordinate”) onto which the current voxel will be projected is already occupied by another voxel, the corresponding coordinate may be the neighboring coordinate of the projection coordinate.

In an image encoding method according to the present disclosure, a bit string may be configured by separating at least one bit from the pixels corresponding to the current voxel in the texture component images, and information on the coefficients of the current voxel may be represented through the remaining bits of the pixels corresponding to the current voxel.

In an image encoding method according to the present disclosure, the bit string may be configured by separating a N-bit from each of the pixels, the N-bit may represent 1-bit information of the bit string, and the N may have a value greater than 1.

In an image encoding method according to the present disclosure, offset information of the current voxel may be encoded through the bit string.

In an image encoding method according to the present disclosure, the offset information may indicate the index of a lower layer to which the current voxel belongs among the lower layers for a basic layer configuring the multi-layer structure.

In an image encoding method according to the present disclosure, occupancy information of the current voxel may be encoded through the bit string.

In an image encoding method according to the present disclosure, the occupancy information may indicate whether the corresponding coordinate is the same as a coordinate onto which the current voxel will be projected.

In an image encoding method according to the present disclosure, the texture component images are classified into a plurality of image groups, and when the pixel of a coordinate onto which the current voxel will be projected is already occupied by another voxel in a first image group among the plurality of image groups, the current voxel may be projected onto a second image group having a central axis different from the first image group.

In an image encoding method according to the present disclosure, the two-dimensional images may further include transparency component images, and the transparency component images may include at least one of transparency information, size information or rotation information of the voxels.

In an image encoding method according to the present disclosure, the size information may represent the radius of each of the x-axis, y-axis and z-axis of a voxel, and the rotation information may represent the degree of rotation for each of the x-axis, y-axis and z-axis of the voxel.

In an image encoding method according to the present disclosure, encoding two-dimensional images of the multi-layer structure may include packing the two-dimensional images into one integrated image; and encoding the integrated image.

An image decoding method according to the present disclosure may include decoding two-dimensional images of a multi-layer structure from a bitstream; and reconstructing a point cloud from the two-dimensional images. In this case, the two-dimensional images may include as many texture component images as the number of coefficients of spherical harmonics.

According to the present disclosure, a computer readable recording medium recording instructions for executing an image encoding method/an image decoding method may be provided.

The technical objects to be achieved by the present disclosure are not limited to the above-described technical objects, and other technical objects which are not described herein will be clearly understood by those skilled in the pertinent art from the following description.

### [Technical Effect]

According to the present disclosure, a method for efficiently encoding/decoding voxels on a three-dimensional space based on images of a multi-layer structure may be provided.

According to the present disclosure, image quality may be improved by enabling texture representation considering reflected light based on spherical harmonics.

According to the present disclosure, reconstruction quality may be improved by minimizing the loss of voxels in the process of being projected onto a two-dimensional plane.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a block diagram of an immersive video processing device according to an embodiment of the present disclosure.

FIG. 2 is a block diagram of an immersive video output device according to an embodiment of the present disclosure.

FIG. 3 represents a plurality of images captured by using cameras with a different view.

FIG. 4 represents a method of removing redundant data between a plurality of view images.

FIG. 5 shows an example in which an object in a three-dimensional space is captured through a plurality of cameras at a different position.

FIG. 6 shows another configuration diagram of an image encoding device according to an embodiment of the present disclosure.

FIG. 7 shows another configuration diagram of an image decoding device according to an embodiment of the present disclosure.

FIG. 8 shows a unit grid.

FIG. 9 shows the incident aspect of rays on reference points.

FIG. 10 shows a case where the distribution of information represented by a sphere is different according to the order and degree of freedom of spherical harmonics.

FIG. 11 shows an example in which a target space is represented as a three-dimensional grid cluster structure.

FIG. 12 represents an example in which the directional information of a voxel is represented as a multi-layer structure.

FIG. 13 shows an example in which a voxel is positioned on an object surface.

FIG. 14 shows a structure in which lower layers are added between basic layers.

FIG. 15 shows an example in which color information of a voxel is projected onto a basic layer.

FIG. 16 is a diagram for describing an example in which a post-processing algorithm is applied.

FIG. 17 is a flow chart of an image encoding method and an image decoding method according to an embodiment of the present disclosure.

FIG. 18 shows an example in which a two-dimensional image is generated.

FIG. 19 represents a process in which the color information of a vertex is rasterized into a viewport image when the size of vertices positioned on a three-dimensional space is different from each other.

FIG. 20 shows an example in which attribute information is composed of multi-layer images.

FIG. 21 shows an example in which voxels are projected onto a plurality of planes with a different central axis.

FIG. 22 shows an example in which vertices representing a target scene are packed into a two-dimensional atlas.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An immersive video, when a user's viewing position is changed, refers to a video that a viewport image may be also dynamically changed. In order to implement an immersive video, a plurality of input images is required. Each of a plurality of input images may be referred to as a source image or a view image. A different view index may be assigned to each view image.

An immersive video may be classified into 3DoF (Degree of Freedom), 3DoF+, Windowed-6DoF or 6DoF type, etc. A 3DoF-based immersive video may be implemented by using only a texture image. On the other hand, in order to render an immersive video including depth information such as 3DoF+ or 6DoF, etc., a depth image (or, a depth map) as well as a texture image is also required.

It is assumed that the embodiments described below are for immersive video processing including depth information such as 3DoF+ and/or 6DoF, etc. In addition, it is assumed that a view image is configured with a texture image and a depth image.

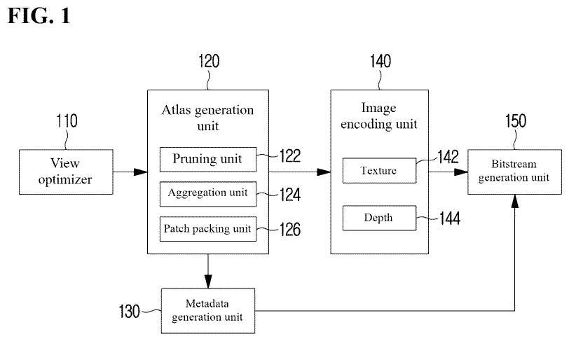

FIG. 1 is a block diagram of a video encoding device according to an embodiment of the present disclosure.

In reference to FIG. 1, a video encoding device according to the present disclosure may include a view optimizer 110, an atlas generation unit 120, a metadata generation unit 130, an image encoding unit 140, and a bitstream generation unit 150.

A video encoding device receives a plurality of pairs of images, intrinsic camera parameters and extrinsic camera parameters as input data to encode an immersive video. Here, a plurality of pairs of images includes a texture image (Attribute component) and a depth image (Geometry component). Each pair may have a different view. Accordingly, a pair of input images may be referred to as a view image. Each of the view images may be divided by an index. In this case, an index assigned to each view image may be referred to as a view or a view index.

Intrinsic camera parameters includes a focal distance, a position of a principal point, etc. and extrinsic camera parameters include translations, rotations, etc. of a camera. Intrinsic camera parameters and extrinsic camera parameters may be treated as a camera parameter or a view parameter.

A view optimizer 110 partitions view images into a plurality of groups. As view images are partitioned into a plurality of groups, independent encoding processing per each group may be performed. In an example, view images captured by N spatially consecutive cameras may be classified into one group. Thereby, view images that depth information is relatively coherent may be put in one group and accordingly, rendering quality may be improved.

In addition, by removing the dependence of information between groups, a spatial random access service which performs rendering by selectively bringing only information in a region that a user is watching may be made available.

Whether view images will be partitioned into a plurality of groups may be optional.

In addition, a view optimizer 110 may classify view images into a basic image and an additional image. A basic image represents an image which is not pruned as a view image with the highest pruning priority and an additional image represents a view image with a pruning priority lower than a basic image.

A view optimizer 110 may determine at least one of the view images as a basic image. A view image which is not selected as a basic image may be classified as an additional image.

A view optimizer 110 may determine a basic image by considering the view position of a view image. In an example, a view image whose view position is the center among a plurality of view images may be selected as a basic image.

Alternatively, a view optimizer 110 may select a basic image based on camera parameters. Specifically, a view optimizer 110 may select a basic image based on at least one of a camera index, a priority between cameras, the position of a camera, or whether it is a camera in a region of interest.

In an example, at least one of a view image with the smallest camera index, a view image with the largest camera index, a view image with the same camera index as a predefined value, a view image captured by a camera with the highest priority, a view image captured by a camera with the lowest priority, a view image captured by a camera at a predefined position (e.g., a central position) or a view image captured by a camera in a region of interest may be determined as a basic image.

Alternatively, a view optimizer 110 may determine a basic image based on the quality of view images. In an example, a view image with the highest quality among view images may be determined as a basic image.

Alternatively, a view optimizer 110 may determine a basic image by considering an overlapping data rate of other view images after inspecting a degree of data redundancy between view images. In an example, a view image with the highest overlapping data rate with other view images or a view image with the lowest overlapping data rate with other view images may be determined as a basic image.

A plurality of view images may be also configured as a basic image.

An Atlas generation unit 120 performs pruning and generates a pruning mask. And, it extracts a patch by using a pruning mask and generates an atlas by combining a basic image and/or an extracted patch. When view images are partitioned into a plurality of groups, the process may be performed independently per each group.

A generated atlas may be composed of a texture atlas and a depth atlas. A texture atlas represents a basic texture image and/or an image that texture patches are combined and a depth atlas represents a basic depth image and/or an image that depth patches are combined.

An atlas generation unit 120 may include a pruning unit 122, an aggregation unit 124, and a patch packing unit 126.

A pruning unit 122 performs pruning for an additional image based on a pruning priority. Specifically, pruning for an additional image may be performed by using a reference image with a higher pruning priority than an additional image.

A reference image includes a basic image. In addition, according to the pruning priority of an additional image, a reference image may further include other additional image.

Whether an additional image may be used as a reference image may be selectively determined. In an example, when an additional image is configured not to be used as a reference image, only a basic image may be configured as a reference image.

On the other hand, when an additional image is configured to be used as a reference image, a basic image and other additional image with a higher pruning priority than an additional image may be configured as a reference image.

Through a pruning process, redundant data between an additional image and a reference image may be removed. Specifically, through a warping process based on a depth image, data overlapped with a reference image may be removed in an additional image. In an example, when a depth value between an additional image and a reference image is compared and that difference is equal to or less than a threshold value, it may be determined that a corresponding pixel is redundant data.

As a result of pruning, a pruning mask including information on whether each pixel in an additional image is valid or invalid may be generated. A pruning mask may be a binary image which represents whether each pixel in an additional image is valid or invalid. In an example, in a pruning mask, a pixel determined as overlapping data with a reference image may have a value of 0 and a pixel determined as non-overlapping data with a reference image may have a value of 1.

While a non-overlapping region may have a non-square shape, a patch is limited to a square shape. Accordingly, a patch may include an invalid region as well as a valid region. Here, a valid region refers to a region composed of non-overlapping pixels between an additional image and a reference image. In other words, a valid region represents a region that includes data which is included in an additional image, but is not included in a reference image. An invalid region refers to a region composed of overlapping pixels between an additional image and a reference image. A pixel/data included by a valid region may be referred to as a valid pixel/valid data and a pixel/data included by an invalid region may be referred to as an invalid pixel/invalid data.

An aggregation unit 124 combines a pruning mask generated in a frame unit in an intra-period unit.

In addition, an aggregation unit 124 may extract a patch from a combined pruning mask image through a clustering process. Specifically, a square region including valid data in a combined pruning mask image may be extracted as a patch. Regardless of the shape of a valid region, a patch is extracted in a square shape, so a patch extracted from a square valid region may include invalid data as well as valid data.

For an unpruned view image, a whole view image may be treated as one patch. Specifically, a whole 2D image which develops an unpruned view image in a predetermined projection format may be treated as one patch. A projection format may include at least one of an Equirectangular Projection Format (ERP), a Cube-map, or a Perspective Projection Format.

Here, an unpruned view image refers to a basic image with the highest pruning priority. Alternatively, an additional image that there is no overlapping data with a reference image and a basic image may be defined as an unpruned view image. Alternatively, regardless of whether there is overlapping data with a reference image, an additional image arbitrarily excluded from a pruning target may be also defined as an unpruned view image. In other words, even an additional image that there is data overlapping with a reference image may be defined as an unpruned view image.

A packing unit 126 packs a patch in a rectangle image. In patch packing, deformation such as size transform, rotation, or flip, etc. of a patch may be accompanied. An image that patches are packed may be defined as an atlas.

Specifically, packing unit 126 may generate a texture atlas by packing a basic texture image and/or texture patches and may generate a depth atlas by packing a basic depth image and/or depth patches.

For a basic image, a whole basic image may be treated as one patch. In other words, a basic image may be packed in an atlas as it is. When a whole image is treated as one patch, a corresponding patch may be referred to as a complete image (complete view) or a complete patch.

The number of atlases generated by an atlas generation unit 120 may be determined based on at least one of the arrangement structures of a camera rig, the accuracy of a depth map, or the number of view images.

A metadata generation unit 130 generates metadata for image synthesis. Metadata may include at least one of camera-related data, pruning-related data, atlas-related data, or patch-related data.

Pruning-related data includes information for determining a pruning priority between view images. In an example, at least one of the flag representing whether a view image is a root node or a flag representing whether a view image is a leaf node may be encoded. A root node represents a view image with the highest pruning priority (i.e., a basic image) and a leaf node represents a view image with the lowest pruning priority.

When a view image is not a root node, a parent node index may be additionally encoded. A parent node index may represent an image index of a view image, a parent node.

Alternatively, when a view image is not a leaf node, a child node index may be additionally encoded. A child node index may represent an image index of a view image, a child node.

Atlas-related data may include at least one of size information of an atlas, number information of an atlas, priority information between atlases or a flag representing whether an atlas includes a complete image. A size of an atlas may include at least one of size information of a texture atlas and size information of a depth atlas. In this case, a flag representing whether a size of a depth atlas is the same as that of a texture atlas may be additionally encoded. When a size of a depth atlas is different from that of a texture atlas, reduction ratio information of a depth atlas (e.g., scaling-related information) may be additionally encoded. Atlas-related information may be included in a “View parameters list” item in a bitstream.

A video encoding device may restore a reduced depth atlas to its original size after decoding information on a reduction ratio of a depth atlas.

Patch-related data includes information for specifying a position and/or a size of a patch in an atlas image, a view image to which a patch belongs and a position and/or a size of a patch in a view image. In an example, at least one of position information representing a position of a patch in an atlas image or size information representing a size of a patch in an atlas image may be encoded. In addition, a source index for identifying a view image from which a patch is derived may be encoded. A source index represents an index of a view image, an original source of a patch. In addition, position information representing a position corresponding to a patch in a view image or position information representing a size corresponding to a patch in a view image may be encoded. Patch-related information may be included in an “Atlas data” item in a bitstream.

An image encoding unit 140 encodes an atlas. When view images are classified into a plurality of groups, an atlas may be generated per group. Accordingly, image encoding may be performed independently per group.

An image encoding unit 140 may include a texture image encoding unit 142 encoding a texture atlas and a depth image encoding unit 144 encoding a depth atlas.

A bitstream generation unit 150 generates a bitstream based on encoded image data and metadata. A generated bitstream may be transmitted to an immersive video output device.

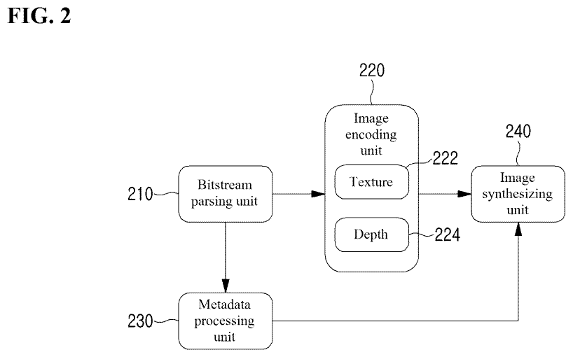

FIG. 2 is a block diagram of an immersive video output device according to an embodiment of the present disclosure.

In reference to FIG. 2, an immersive video output device according to the present disclosure may include a bitstream parsing unit 210, an image decoding unit 220, a metadata processing unit 230 and an image synthesizing unit 240.

A bitstream parsing unit 210 parses image data and metadata from a bitstream. Image data may include data of an encoded atlas. When a spatial random access service is supported, only a partial bitstream including a watching position of a user may be received.

An image decoding unit 220 decodes parsed image data. An image decoding unit 220 may include a texture image decoding unit 222 for decoding a texture atlas and a depth image decoding unit 224 for decoding a depth atlas.

A metadata processing unit 230 unformats parsed metadata.

Unformatted metadata may be used to synthesize a specific view image. In an example, when motion information of a user is input to a video decoding device, a metadata processing unit 230 may determine an atlas necessary for image synthesis and patches necessary for image synthesis and/or a position/a size of the patches in an atlas and others to reproduce a viewport image according to a user's motion.

An image synthesizing unit 240 may dynamically synthesize a viewport image according to a user's motion. Specifically, an image synthesizing unit 240 may extract patches required to synthesize a viewport image from an atlas by using information determined in a metadata processing unit 230 according to a user's motion. Specifically, a viewport image may be generated by extracting patches extracted from an atlas including information of a view image required to synthesize a viewport image and the view image in the atlas and synthesizing extracted patches.

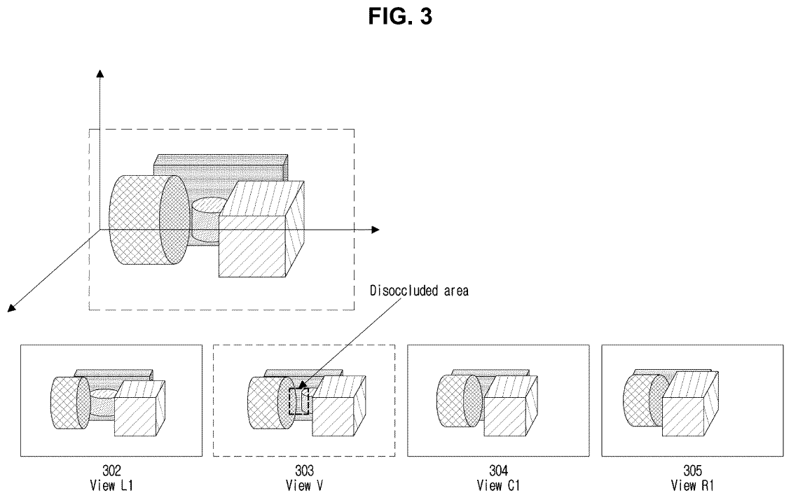

FIG. 3 represents a plurality of images captured by using cameras with a different view.

When ViewC1 304 is referred to as a central view, ViewL1 302 and ViewR 1 305 represent a left view image of a central view and a right view image of a central view, respectively.

When a virtual view image ViewV 303 between a central view ViewC1 and a left view image ViewL1 is generated, there may be a region which is hidden in a central view image ViewC1, but is visible in a left view image ViewL1. Accordingly, image synthesis for a virtual view image ViewV may be performed by referring to a left view image ViewL1 as well as a central view image ViewC1.

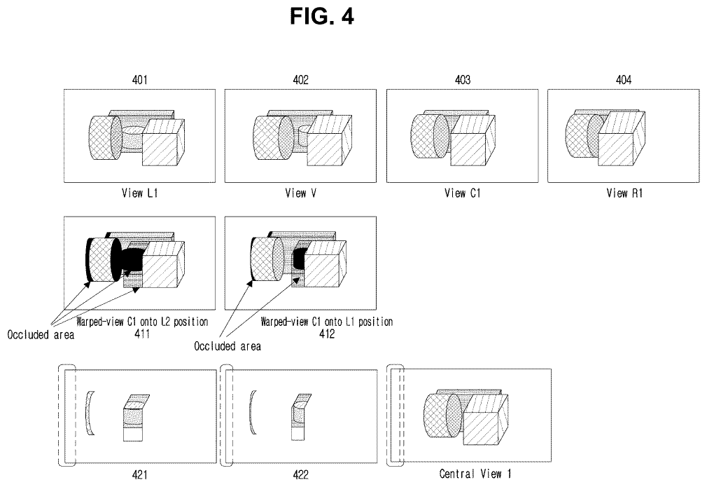

FIG. 4 represents a method of removing redundant data between a plurality of view images.

A basic view among a plurality of view images is selected and for non-basic view images, redundant data with a basic view is removed. In an example, when a central view ViewC1 is referred to as a basic view, remaining views excluding ViewC1 become an additional view used as a reference image in synthesis. All pixels of a basic view image may be mapped to a position of an additional view image by using a three-dimensional geometric relationship and depth information (depth map) of each view image. In this case, mapping may be performed through a 3D view warping process.

In an example, as in an example shown in FIG. 4, a basic view image ViewC1 may be mapped to a position of a first left view image ViewL1 402 to generate a first warped image 412 and a basic view image ViewC1 may be mapped to a position of a second left view image ViewL2 401 to generate a second warped image 711.

In this case, a region which is invisible due to observation parallax in a basic view image ViewC1 is processed as a hole region without data in an warped image. A region where data (i.e., a color) exists except for a hole region may be a region which is also visible in a basic view image ViewC1.

A pruning process for removing an overlapped pixel may be performed through a procedure for confirming whether an overlapped pixel between a basic view and an additional view may be determined as redundancy. In an example, as in an example shown in FIG. 4, a first residual image 722 may be generated through pruning between a first warped image and a first left view image and a second residual image 721 may be generated through pruning between a second warped image and a second left view image. By reducing image data through a pruning process, compression efficiency may be improved in encoding an image.

Meanwhile, a determination on an overlapped pixel may be based on whether at least one of a color value difference and/or a depth value difference for pixels at the same position is smaller than a threshold. In an example, when at least one of a color value difference and a depth value difference is smaller than a threshold, both pixels may be determined to be overlapped pixels.

In this case, a case may occur in which they are determined to be an overlapped pixel although they are not an overlapped pixel due to a problem such as a color or a depth value noise in an image, an error in a camera calibration value or an error in a decision equation. In addition, a case may also occur in which a color value is different depending on the position of a camera used to capture the pixel due to a characteristic of a reflective surface of various materials in a scene and a source of light even between pixels at the same position. Accordingly, although a pruning process is very accurate, information expressing a scene may be lost, which may cause image quality deterioration when rendering a target view image in a decoder.

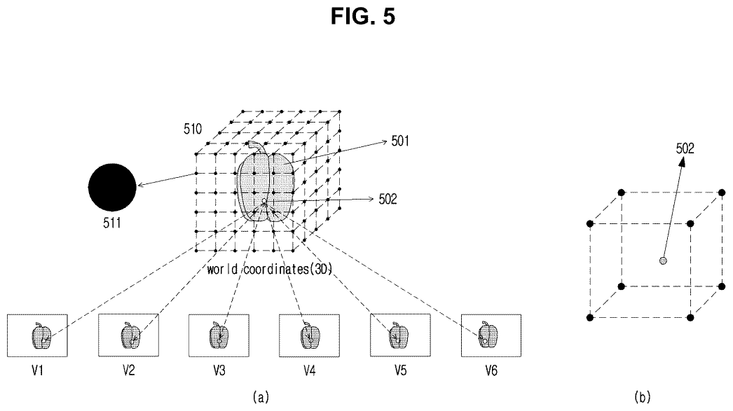

FIG. 5 shows an example in which an object in a three-dimensional space is captured through a plurality of cameras at a different position.

In FIG. 5(a), it is assumed that each image is projected into a two-dimensional image.

In FIG. 5(a), V1 to V6 represent view images captured by cameras having a different capturing angle (pose). As in a shown example, according to a capturing angle (pose) and a position of a camera acquiring an object, even the same point in a three-dimensional space may have a different aspect of being projected into a two-dimensional image. In an example, when an any one point 502 on an object is projected on each of view images V1 to V6, according to a camera capturing angle (pose), a pixel value corresponding to the any one point 502 in a projected two-dimensional image may be not the same, but different between corrective images.

Similarly, object 501 shown in FIG. 5(a) may also have different brightness per view due to a characteristic of a reflective surface and a light source.

However, when pixels corresponding to any one point 502 on an object in view images are determined to be an overlapped pixel, through a pruning process, a pixel in a basic view image is maintained and a pixel in an additional view image is removed. In other words, although pixels corresponding to any one point 502 on an object in view images have different brightness, if a difference in depth values (or color values) is less than or equal to a threshold value, they are determined as an overlapped pixel.

A pruning process removes data redundancy to improve data compression efficiency, but as in the example, determines pixels with different brightness as an overlapped pixel to cause a loss in information quantity, resulting in image quality deterioration in rendering in a decoder.

In particular, a color value on a surface such as a mirror that an incident light source is totally reflected or a transparent object that an incident light source is refracted, not a diffused reflection surface, may be determined as an overlapping pixel and removed in a pruning process although a color value is totally different according to an angle.

In order to reconstruct a color value of a real mixed reflective surface which looks different according to an observer's viewing position and angle, it is required to have information for all viewing angles as well as a specific angle or a method of modeling a reflective characteristic of a mixed reflective surface may be considered.

Meanwhile, the above-described embodiments relate to data compression of an immersive video. In other words, embodiments shown in FIGS. 1 to 5 aim to reconstruct an image for a three-dimensional space based on a decoded immersive image after decoding an encoded immersive image.

Recently, a discussion on deep learning-based image processing methods has also been actively conducted. As an example, instead of depth map-based rendering used traditionally, a technology that receives a plurality of images for a target scene or a target three-dimensional space as an input and models a radiance field is in the spotlight. Here, modeling of a radiance field or Gaussian splats may be performed by inputting a plurality of images into a neural network.

Meanwhile, a radiance field represents a function or a data structure that represents the characteristic of light for all points in a three-dimensional space. As an example, the characteristic of light may represent how incident light is reflected when passing through each point.

A technology for modeling a radiance field in a three-dimensional space may be called Neural Radiance Field (NeRF).

When using NeRF, it is possible to more realistically reconstruct a non-Lambertian region, etc. which may not be expressed by using a traditional image synthesis method. In addition, the existing complex equations or algorithms may be replaced with a deep learning process, i.e., a neural network learning process.

In addition to NeRF, explicit feature information may also be utilized. Specifically, a scene on a target space may be expressed in a form such as a voxel grid, and feature information that may express a voxel grid may be calculated through a model training process.

As an example, FIG. 5(a) shows an example in which a three-dimensional region of interest to which an object in a target scene belongs is expressed in a three-dimensional grid structure. In an example shown in FIG. 5(a), it was illustrated that a space including an object 501 is expressed in a three-dimensional grid structure expressed by a world coordinate system. Here, a three-dimensional grid structure means a cluster where three-dimensional vertices are arranged at an equal interval, and as an example, sign 511 approximates one of the three-dimensional vertices in a sphere shape. As in an example shown in FIG. 5(b), any point 502 represents a three-dimensional vertex corresponding to any intermediate position in a three-dimensional grid structure. Meanwhile, each of a plurality of vertices may be referred to as a voxel.

When a target space is configured with three-dimensional grids in a unit of a voxel, a feature vector that may embody color information and density information of a corresponding region may be allocated to each vertex.

A feature vector for a three-dimensional point at any position in a three-dimensional space may be calculated by trilinearly interpolating feature vectors of neighboring vertices (e.g., 8 vertices configuring a cube that includes a point at any position). In other words, color and density information for a three-dimensional point at any position may be obtained through the trilinear interpolation of feature vectors of neighboring vertices.

The NeRF technology using explicit feature information must express a target space with a three-dimensional grid, which causes an increase in data capacity. Due to an increase in data capacity, restrictions on model file storage and inference may occur. Accordingly, a structure that encodes/decodes feature information of a target space may be considered by utilizing a server-client model.

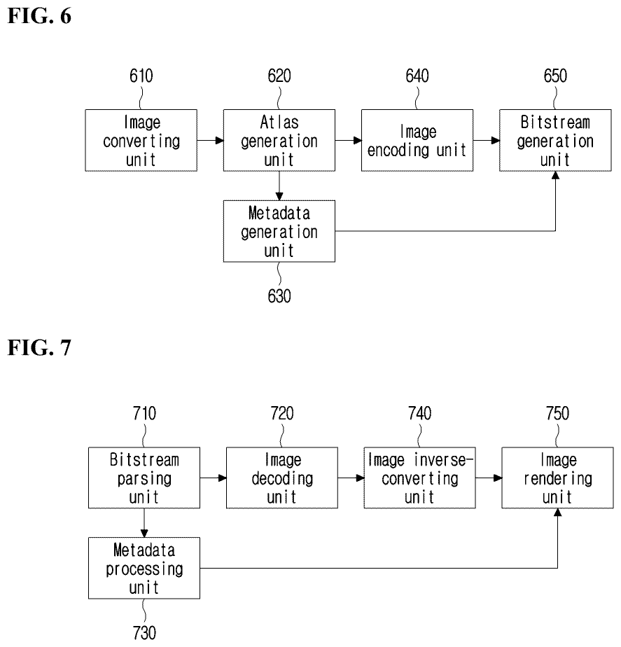

In order to encode/decode feature information of a target space, the configuration of an image encoding device and an image decoding device in FIGS. 1 and 2 may be modified. As an example, FIG. 6 shows another configuration diagram of an image encoding device according to an embodiment of the present disclosure, and FIG. 7 shows another configuration diagram of an image decoding device according to an embodiment of the present disclosure.

Referring to FIG. 6, an image encoding device may include an image transformer 610, an atlas generator 620, a metadata generator 630, an image encoder 640 and a bitstream generator 650.

An image transformer 610 generates a plurality of 2D images from an input point cloud. In this case, a plurality of 2D images may form a multi-layer structure.

An atlas generator 620 may generate an atlas by packing a plurality of 2D images or patches extracted from a plurality of 2D images.

A metadata generator 630 may generate metadata for an atlas and/or a patch.

An image encoder 640 may encode a generated atlas. Meanwhile, when the encoding of an atlas is omitted, an image encoder 640 may directly encode a plurality of 2D images obtained by converting a point cloud.

A bitstream generator 650 may generate a bitstream including encoded image data and metadata and transmit it to a decoding device.

Referring to FIG. 7, an image decoding device may include a bitstream parsing unit 710, an image decoder 720, a metadata processor 730, an image inverse transformer 740 and an image rendering unit 750.

A bitstream parsing unit 710 may receive a bitstream from an encoding device and separate a received bitstream into image data and metadata.

An image decoder 720 may decode image data to reconstruct an atlas. Meanwhile, when the generation of an atlas is omitted, an image decoder 720 may decode image data to reconstruct a plurality of 2D images.

A metadata processor 730 may decode metadata.

An image inverse transformer 740 may reconstruct a point cloud based on a decoded image and metadata.

An image rendering unit 750 may render a part corresponding to a viewport in a decoded point cloud.

Hereinafter, embodiments of encoding/decoding feature information of a target space will be described in detail.

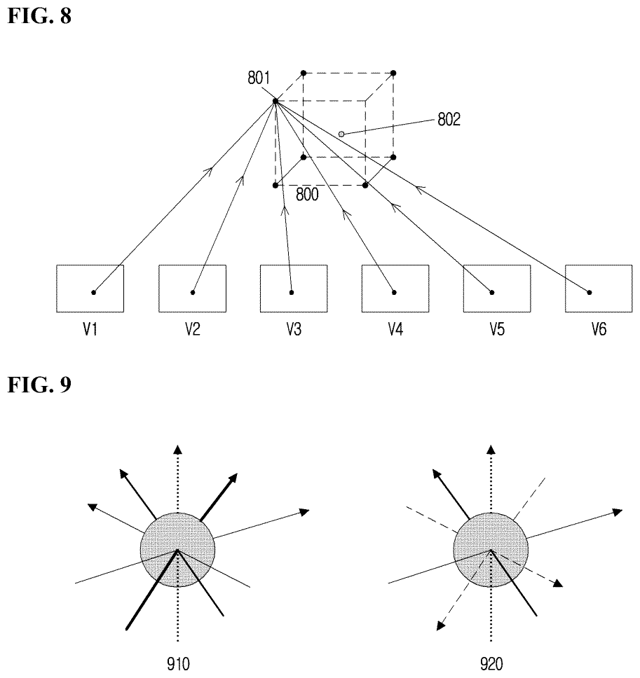

FIG. 8 shows a unit grid.

In FIG. 8, it was shown that unprojection is performed in the form of a ray on a vertex 801 configuring a unit grid from the pixel of each viewpoint image (V1 to V6). As in a shown example, camera calibration information corresponding to a viewpoint image may be used to perform unprojection in the form of a ray on a vertex 801 configuring a unit grid from the pixel of a viewpoint image. In this case, when the color value of a ray projected on a vertex 801 from each viewpoint image is referenced, the color value of a vertex 801 for any viewpoint may be estimated.

Furthermore, when the color value of the eight vertices configuring a grid 800 may be estimated by referring to pixels in viewpoint images (V1 to V6), at least one of a color value, a brightness value or an opacity value for any point 1002 in a grid may also be estimated. In other words, eight vertices configuring a grid may be used as reference vertices to estimate information on a target point 802 in a grid by using a method such as the three-dimensional linear interpolation (tri-linear interpolation), average or weighted operation of reference vertices.

Meanwhile, in an example shown in FIG. 8, each point defining a grid unit may be expanded into a form having a three-dimensional volume. As an example, it may be defined as a three-dimensional shape such as a sphere or an ellipsoid centered on a vertex. For this, size information of each vertex configuring a grid may be required.

Here, when the size (scaling) of each vertex configuring a grid is the same, information on a target point may be estimated by a simple method such as three-dimensional linear interpolation, etc. On the other hand, when the size of vertices configuring a grid is different from each other, a size component may be modeled as an additional parameter so that an occupied area (or space) when color and intensity information of a ray for a vertex projected on a viewport image is rasterized may be variable when a vertex 801 is projected on a target viewpoint. Through this, representation may be optimized for rendering the target scene with the high-quality.

In other words, based on size information, a weight may be set based on occupancy at a position where each vertex is projected in each size onto a viewport image and rasterized, and a pixel finally determined through the weight operation of vertices projected onto the same position may be optimized based on a loss function with the pixel value of a reference view image, estimating the component information of a target point 801 configuring a voxel.

Meanwhile, size information may basically represent the radius of a circle or a sphere. In this case, for a vertex existing on a three-dimensional space, a radius for each of a x-axis, a y-axis and a z-axis may be individually set. When a radius for at least one of a x-axis, a y-axis and a z-axis is different from other axes, it shows that the shape of a vertex is an ellipsoid. The method may be applied to a three-dimensional grid cluster to reconstruct a target object for any viewpoint. Meanwhile, as an interval between vertices configuring a three-dimensional grid cluster surrounding a target object is closer, a target object may be reconstructed with higher resolution.

In order to reconstruct a target object by using the method, a color value according to the incident angle (i.e., shooting angle) of a ray unprojected from each camera must be known for all reference vertices configuring a three-dimensional grid cluster for a target object.

Meanwhile, the number of lines passing through a reference vertex in the form of a ray may be variable by at least one of the number of cameras (i.e., viewpoint images), the resolution of an image or a camera geometric structure.

The more diverse the angles of rays incident from cameras (i.e., viewpoint images) to a reference vertex, the more accurately the color values by incident angle or direction of a target point may be reconstructed. In other words, as more reflected light information shows information when a light source reflected from a target point is projected onto each camera (i.e., each viewpoint image) (i.e., as the reflected light information of a light source is obtained at various angles), a target point may be reconstructed realistically at various viewpoints and directions.

As in an example shown in FIG. 5(a), when a reference vertex is assumed to have the shape of a sphere 511 with a radius of r, a color value at the moment when a ray is reflected while passing through a corresponding reference vertex may be stored as reflected light information. Meanwhile, the reflected light information may be stored for each incident angle (direction) of a ray.

Reflected light information may be utilized to reconstruct an appropriate color according to an angle at which a corresponding reference vertex is observed when synthesizing an image at any viewpoint.

Meanwhile, the number of rays that are unprojected from a view image and incident on a reference point may be different for each reference point.

FIG. 9 shows the incident aspect of rays on reference points.

In an example shown in FIG. 9, it was illustrated that five rays are incident on the first reference point 910 and three rays are incident on the second reference point 920. Since the number of rays incident on the first reference point 910 is greater than the number of rays incident on the second reference point 920, it may be understood that incident light source information for the first reference point 910 is more diverse than incident light source information for the second reference point 920. Accordingly, when synthesizing an arbitrary view image, the first reference point 910 may be reconstructed with more realistic colors at more diverse angles than the second reference point 920.

However, the maximum number of rays incident on each of the first reference point 910 and the second reference point 920 is limited to the number of view images (i.e., cameras), and accordingly, incident light source information may be obtained only for an incident angle corresponding to each of the view images. In other words, since incident light source information is not obtained for all omnidirectional angles, information on an arbitrary direction (angle) on which a ray is not incident may be obtained through approximation using a neighboring value.

In other words, information such as the color of a ray reflected from a reference point may be set as a neighboring value, and a color value in a direction or a space on which a ray is not incident may be estimated by using at least one neighboring value.

Meanwhile, when a reference vertex is assumed to have the shape of a sphere, the distribution of the reflected light intensity on a sphere may be approximated based on a neighboring value through Laplace's equation in the spherical coordinate system (spherical coordinates) in the shape of a sphere. As an example, the distribution of reflected light intensity may be approximated by using a spherical harmonic function (spherical harmonics).

Equation 1 below represents a spherical harmonic function.

$${Y}_{l , m} ( θ , ϕ ) = \{ \begin{matrix}{c}_{l , m} {P}_{l}^{\vert m \vert} ( cos θ ) sin ( \vert m \vert ϕ ) & - l \leq m \leq 0 \\ \frac{{c}_{l , m}}{\sqrt{2}} {P}_{l}^{0} ( cos θ ) & m = 0 \\ {c}_{l , m} , {P}_{l}^{m} ( cos θ ) cos ( m ϕ ) & 0 \leq m \leq l\end{matrix} \qquad [ Equation 1 ]$$

In Equation 1, Y_{I,m} represents a spherical harmonic function. θ is an angle with a z-axis in a positive direction in a spherical coordinate system, and φ is an angle with a x-axis in a positive direction with a z-axis as an axis. Since a function is continuous, I is a non-negative integer, and m is an integer satisfying −I≤m≤I.

In Equation 1, C_{I,m} may be derived according to Equation 2 below.

$${c}_{l , m} = \sqrt{\frac{2 l + 1}{2 π} \frac{( l + \vert m \vert ! )}{( l + \vert m \vert ! )}} \qquad [ Equation 2 ]$$

In addition, in Equation 1, P_{I}^{m} represents Legendre Polynomials.

When a spherical harmonic function that approximates the distribution of reflected light components at a spherical target point is called \tilde{f}, \tilde{f} may be represented as the weighted sum of spherical harmonic functions (basis functions) Y_{I,m} of reference vertices as in Equation 3 below.

$$\tilde{f} ( θ , ϕ ) = {\sum }_{l , m} {c}_{l m} {Y}_{l m} ( θ , ϕ ) \qquad [ Equation 3 ]$$

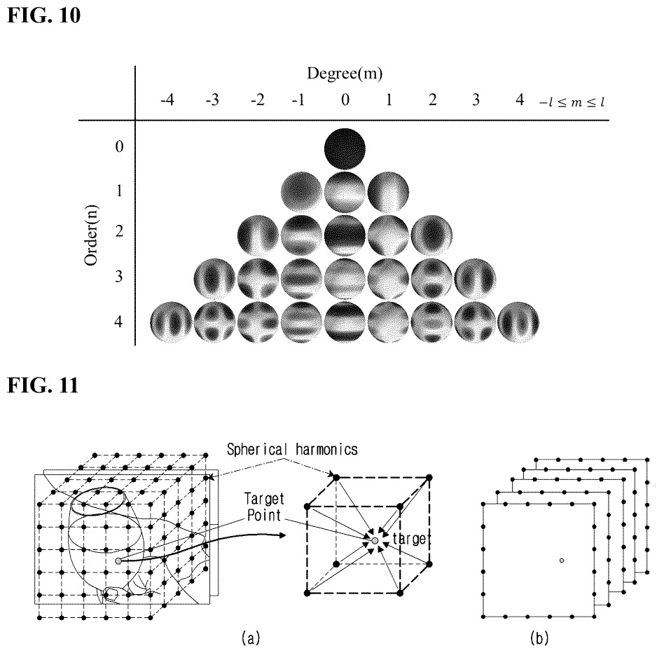

FIG. 10 shows a case where the distribution of information represented by a sphere is different according to the order and degree of freedom of spherical harmonics.

In an example shown in FIG. 10, when it is assumed that the order of spherical harmonics is 2, the spherical harmonics of a target point may be approximated by 9 basis functions, which are the sum of information that may be represented in order less than or equal to 2 (1 when the order is 0, 3 when the order is 1, and 5 when the order is 2). The spherical harmonics of a target point may be approximated by 16 basis functions when the order of spherical harmonics is 3 and by 25 basis functions when the order is 4. Here, the number of basis functions may be the same concept as the number of coefficients that configure spherical harmonics.

As the order of a spherical harmonic function increases, reflected light component information corresponding to a local region on a spherical coordinate system may be approximated by distinguishing it from other regions. In other words, as the order of a spherical harmonic function increases, the high-frequency component of reflected light expressed in a local region on a spherical coordinate system is included.

The intensity by orientation of reflected light component information that may be expressed by a corresponding sphere may be approximated by referring to the intensity of a ray incident on a spherical target point. Specifically, when the order of a spherical harmonic function is 2, a weight function for a total of 9 basis functions may be calculated to approximate a spherical harmonic function for a target point.

In this case, when there is information on a coefficient corresponding to the weight of a basis function Y_{i,m} in Equation 3, it may be used to approximate a target point and accordingly, reflected light information in any direction may be reconstructed. In order to approximate the intensity of trichromatic circles R, G, B, the weight of a basis function must be calculated by referring to the intensity of each channel individually.

The above-described spherical harmonic function may be applied to a video encoder/decoder structure to reconstruct a pixel value for a target point at any viewpoint. Specifically, in an encoder, the coefficient of basis functions may be stored in an attribute and encoded in an image format or may be encoded in a metadata format and transmitted to a decoder. In a decoder, reflected light information in any direction for a target point may be reconstructed by using a received coefficient. In this case, the minimum size of data for encoding a coefficient may be a value obtained by multiplying the number of vertices configuring a three-dimensional grid cluster by the number of basis functions (the number of coefficients) of a spherical harmonic function as in Equation 4 below.

$$Minimum Metadata size = Number of Elements \times Number of Coefficients \times Data size per Coefficient \qquad [ Equation 4 ]$$

In addition, size information for determining the size of a vertex configuring a three-dimensional grid cluster may also be encoded/decoded together. As an example, the size information may include information showing the radius of a circle or a sphere. Alternatively, the size information may include information showing a radius for each of a x-axis, a y-axis and a z-axis.

Meanwhile, information showing the shape of a vertex may also be additionally encoded/decoded. As an example, when shape information indicates that a vertex is circular or spherical, information showing a radius may be encoded and signaled only for one of a x-axis, a y-axis and a z-axis. On the other hand, when shape information indicates that a vertex is elliptical, information showing a radius may be encoded and signaled for each of a x-axis, a y-axis and a z-axis.

Meanwhile, the position of a vertex must also be encoded/decoded together with a spherical harmonic function. When the position of each vertex is directly encoded/decoded, a large amount of bits are required to encode/decode the position of vertices. In order to reduce the amount of data required to encode the positions of a vertix, vertices may be arranged in a multi-layer format.

FIG. 11 shows an example in which a target space is expressed as a three-dimensional grid cluster structure.

In an example shown in FIG. 11(a), for a voxel unit grid cluster, the opacity and a spherical harmonic function coefficient for all vertices may be obtained according to Equation 5.

Equation 5 shows an equation for deriving the opacity and a color value for N reference points located along a ray, in a process in which a ray is unprojected in the direction of a target scene from each pixel in a plurality of reference viewpoint images. Here, a reference point represents a point through which a ray passes.

$${C}_{R} ( r ) = {\sum }_{i = 1}^{N} {T}_{i} ( 1 - exp ( - {σ}_{i} {δ}_{i} ) ) {c}_{i} \qquad [ Equation 5 ]$$

In Equation 5 above, C_{R}(r) represents the reconstructed color value of an input ray. N represents the number of reference points on a corresponding ray and i represents the index of each reference point. σ represents opacity, δ represents an interval (i.e., an offset) between reference points and c represents a color value. Tᵢ represents the transmittance of a reference point where an index is i. The transmittance Tᵢ of a reference point may be derived as in Equation 6 below.

$${T}_{i} = exp ( - {\sum }_{j = 1}^{i - 1} {σ}_{j} {δ}_{j} ) \qquad [ Equation 6 ]$$

The reference points on a ray processed by Equation 5 may be processed sequentially in order of distances from a camera. In this case, as shown in Equation 6, the i-th reference point may be derived by referring to the accumulated opacity σⱼ and the accumulated interval δⱼ to a previous reference point (i.e., the i-1-th reference point).

In Equation 5, cᵢ represents the color value of the i-th reference point and a corresponding value may vary depending on the direction of a ray. Accordingly, the color value cᵢ of a reference point may be derived based on a spherical harmonic function.

The color C_{R}(r) of a ray reconstructed by Equation 5 may be determined as a value that minimizes the difference with the value of an original viewpoint image (i.e., C (r)). As an example, the optimal color value C_{R}(r) of a reconstructed ray may be obtained through an optimization process by Equations 7 and 8 below.

$${L}_{recon} = \frac{1}{\vert R \vert} {\sum }_{r ∈ R} {‖ C ( r ) - \hat{C} ( r ) ‖}_{2}^{2} \qquad [ Equation 7 ]$$

$$L = {L}_{recon} + {λ}_{0} \qquad [ Equation 8 ]$$

As in an example of Equation 7, for each ray belonging to Set R, the difference between a reconstructed color value C_{R}(r) and the color value C (r) of an original image corresponding thereto may be derived and a loss cost L_{recon} may be derived by averaging difference values for all rays belonging to Set R. Afterwards, after applying a weight A to an additional loss cost a calculated by an additional constraint, a loss cost L_{recon} and a weighted additional loss cost Aa may be combined to derive the total loss cost L. Among a plurality of viewpoints, based on a viewpoint when the total loss cost L derived from Equation 8 is low, a reconstructed color value C_{R}(r) for all rays may be derived.

When a reconstructed color value C_{R}(r) is derived, the coefficient of a spherical harmonic function and an opacity value at the position of vertices configuring a target scene may be derived.

Meanwhile, opacity may also be called occupancy. The value of opacity or occupancy may represent a probability that incident light will be reflected or transmitted by a particle in a three-dimensional space at each vertex. As an example, when incident light will be highly likely reflected by a particle in a three-dimensional space, it may mean that a corresponding vertex is highly likely to be positioned on the surface of an object or background. Considering the characteristic, the value of opacity or occupancy may be utilized as a probability value for deriving a distance (i.e., a depth value) between a vertex and a camera by using the geometric information of a target scene (e.g., the camera calibration information of a target scene).

In order to reconstruct a vertex in a target space represented as a three-dimensional grid cluster structure (hereinafter referred to as a target vertex), reference vertices near a target vertex may be used. Specifically, the color value, brightness value or opacity of a target vertex may be obtained through the tri-linear interpolation of the color value, brightness value or opacity of eight vertices of a grid (i.e., eight points) to which a target vertex belongs.

Meanwhile, a multi-layer structure may be used as a method for representing a three-dimensional grid cluster. Specifically, a plurality of layers are stacked, and in this case, the resolution of each layer may be the same as the number of three-dimensional voxels configuring one plane (or, cross section) of a grid cluster. In this case, when it is assumed that the coordinate of each vertex is defined as x, y, and z coordinates, one plane of a grid cluster may be a set of vertices having the same x-axis coordinate, y-axis coordinate, or z-axis coordinate (refer to FIG. 11(b)). In this case, one plane of a grid cluster may be called a layer plane or a reference plane.

In addition, a spherical harmonic function may be allocated to vertices configuring each grid and the number of layers for a reference plane may exist as many as the number of coefficients of a spherical harmonic function. As an example, the i-th layer may include the i-th spherical harmonic function coefficient for each vertex in a reference plane.

Meanwhile, when the order of a spherical harmonic function is 0, data to be encoded/decoded has a structure similar to that of general image data. On the other hand, when the order of a spherical harmonic function is greater than or equal to 1, a basis function in more directions may be utilized according to the order and the degree of freedom, and accordingly, directional data for covering multiple directions is required.

In other words, as the order and the degree of freedom increase, directional data that may be expressed increases, and accordingly, the number of layers configuring a reference plane may increase.

Meanwhile, when a multi-layer structure is used, layers may be stacked similarly to a MultiPlane Images (MPI) structure. Specifically, an MPI structure is generated by arranging a plurality of layered images along the z-axis direction within a specific depth range, based on a specific reference viewpoint for a three-dimensional volumetric scene. In this case, a z-axis may represent a depth value and a spacing interval (i.e., a depth value difference) between a plurality of layered images may be constant.

An MPI structure image is composed of color information and transparency information of each layered image. In this case, color information for a layered image may be obtained by reprojecting a reference viewpoint image onto the plane of a corresponding layer. In addition, transparency information represents the level of transparency of all pixels in a layered image.

In other words, in an MPI structure, a texture image and a transparency image for a layered image may be encoded/decoded, respectively.

In the present disclosure, a method for encoding/decoding the directional information of a voxel is proposed by utilizing an MPI structure described above.

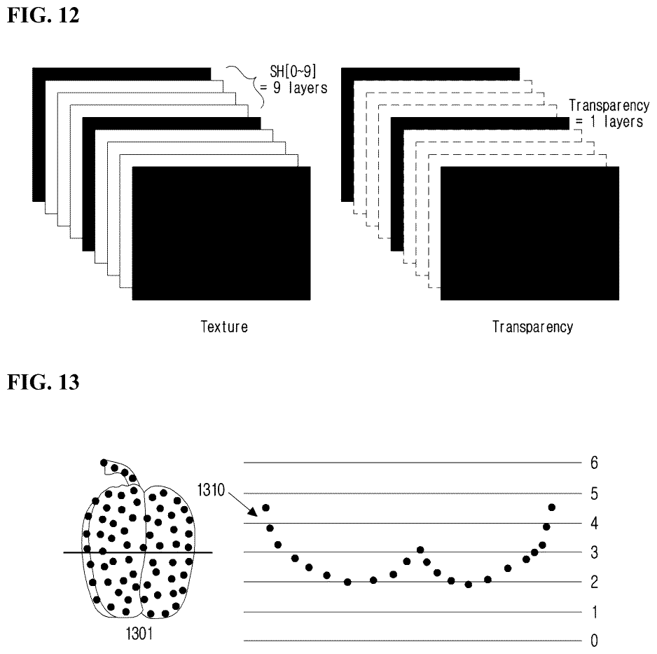

FIG. 12 represents an example in which the directional information of a voxel is expressed as a multi-layer structure.

The directional information of a voxel may be encoded/decoded by using texture images, i.e., texture layers, of an MPI structure.

Since the directional information of a voxel is represented by spherical harmonic function coefficients, texture layers may include information of spherical harmonic function coefficients.

Meanwhile, the number of layers for encoding/decoding the directional information of a voxel may be the same as the number of spherical harmonic function coefficients. As an example, when the number of spherical harmonic function coefficients is 9, the number of texture layers corresponding to one plane (i.e., reference plane) of a grid cluster may be 9.

Meanwhile, as described through Equation 5 above, opacity of a vertex is required to obtain the color information of a vertex. The opacity for all vertices may be set as a transparency layer. Here, opacity and transparency mean the same information, although they are just different descriptive terms.

Meanwhile, for one plane (i.e., reference plane) of a grid cluster, only one transparency layer may exist.

In other words, when the coefficients of a spherical harmonic function are N, the number of texture layers corresponding to a reference plane may be N, while the number of transparency layers may be 1.

However, in an MPI structure, a transparency image is utilized not only for a transparency value, but also for patch masking. Considering this, as many transparency layers as the number of texture layers may be generated.

However, when the number of transparency layers is increased by the number of texture layers, a problem occurs that the amount of data to be encoded/decoded increases.

Accordingly, for efficient memory usage, a plurality of transparency layers may be stored in an asymmetric state and when performing an actual operation, as many reference transparency layers as the number of texture layers may be copied and processed. Here, an asymmetric state means that the number of texture layers and the number of transparency layers are not the same.

Alternatively, a valid region between transparency layers may be set differently. In other words, a target view image is reconstructed by using only data within a valid region within a transparency layer, but the position and/or size of a valid region between transparency layers may be set differently.

Identification information for identifying the attribute of a layer may be encoded/decoded. As an example, a syntax attribute_type_id may be an identifier representing one of a plurality of attributes. A plurality of attributes may include texture and transparency.

Meanwhile, an attribute between a layer including a coefficient with the smallest index among the spherical harmonic function coefficients (i.e., the first coefficient of a spherical harmonic function) and a layer including a coefficient other than a coefficient with the smallest index may be set differently. As an example, the attribute of a layer including a coefficient with the smallest index or a transparency layer corresponding thereto may indicate texture or transparency, while the attribute of a layer including a coefficient other than a coefficient with the smallest index or a transparency layer corresponding thereto may indicate an attribute different from texture or transparency. Here, an attribute different from texture or transparency may be an attribute (e.g., an additional coefficient or additional transparency, etc.) newly defined for a layer including a coefficient other than a coefficient with the smallest index or a transparency layer corresponding thereto.

As described above, when encoding/decoding the directional information of a voxel based on a multi-layer structure, the amount of data to be encoded/decoded increases as the resolution of a layer and the number of coefficients of a spherical harmonic function are larger. As the amount of data increases, an efficient data processing method is required to improve the amount of data processing or algorithm performance.

As described above, each voxel configuring a grid has color intensity information and transparency information according to a direction through spherical harmonic function coefficients. However, when a target scene is reconstructed, all voxels do not have a significant influence.

Considering this, when an actual target scene is reconstructed, how information held by a voxel has influence may be calculated in advance and then, the amount of data to be encoded/decoded may be reduced for a voxel with small influence. Specifically, the amount of data to be encoded/decoded may be reduced by either pruning (i.e., removing) the information about a voxel with small influence or by quantizing information about a voxel with small influence.

As another example of processing data representing a three-dimensional volumetric space, only a part of a target space, not the entire region, may be represented using a multi-layer structure. Specifically, the need for directional information when rendering a target three-dimensional space arises from the fact that color may vary depending on the viewer's perspective. In other words, by encoding/decoding viewpoint-dependent information that is dependent on a user's viewpoint, a target three-dimensional space may be rendered according to a user's viewpoint.

However, in diffuse reflection region such as a Lambertian Region, color information by direction (i.e., by viewpoint) does not vary significantly. In other words, storing directional information in a diffuse reflection region may cause the effect of encoding/decoding unnecessary data.

Accordingly, only a part of a three-dimensional space, not the entire region, may be expressed in a multi-layer structure. As an example, only a non-Lambertian region in a three-dimensional space may be expressed in a multi-layer structure, or only residual regions excluding a Lambertian region in a three-dimensional space may be expressed in a multi-layer structure.

Meanwhile, encoding/decoding using a patch may be performed for a region that is not expressed in a multi-layer structure (i.e., a region that is expressed in a single-layer structure). In other words, a patch image (i.e., an atlas) for a region not expressed in a multi-layer structure may be generated and a region not expressed in a multi-layer structure may be reconstructed by encoding/decoding a patch image.

As another example, spherical harmonic function coefficients may be set differently depending on a depth. As an example, when the first cross section of a grid cluster corresponds to a non-Lambertian region while the second cross section of a grid cluster corresponds to a Lambertian region, the number of spherical harmonic function coefficients for the first cross section may be greater than the coefficient of spherical harmonic function coefficients for the second cross section. Accordingly, the number of texture layers for a first cross section may be greater than the number of texture layers for a second cross section. As an example, a first cross section may be expressed by a plurality of texture layers, while a second cross section may be expressed by a single texture layer or a smaller number of texture layers than the first cross section.

A multi-layer structure is generated by converting the attribute of voxels into an image format and arranging/packing converted images in a depth direction. Meanwhile, a multi-layer structure may be encoded/decoded based on a general video codec (e.g., AVC, HEVC, VVC, VP9, or AV1, etc.).

Meanwhile, an attribute for storing a value that may represent the attribute of voxels, not the coefficient value of a spherical harmonic function, may be additionally defined. As an example, when the attribute of a layer is represented as a feature map, a layer may be represented in the form of a feature vector which is mainly used in scene representation in NeRF.

After generating a directional image in a multi-layer structure proposed in the present disclosure, in order to encode/decode it, the directional image configuration information of a multi-layer structure may be additionally encoded/decoded. Here, directional image configuration information may include at least one of the total number of layers, the resolution (i.e., a width and/or a height) of a layer image or a reference plane, the depth information of a reference plane, an interval between reference planes (calculated based on at least one of a x-axis, a y-axis or a z-axis), the number information of spherical harmonic function coefficients of each voxel or each layer plane, basis function information, the camera calibration information of reference image(s) or camera calibration information for a reference viewpoint position. Here, basis function information may be necessary for reconstructing color information and/or transparency information based on spherical harmonic function coefficients. In addition, a reference image may represent an image used for configuring the directional image of a multi-layer structure. Meanwhile, the directional image configuration information of a multi-layer structure may be encoded/decoded as metadata.

A receiving terminal may receive and decode the directional image configuration information of a multi-layer structure to reconstruct a target viewpoint image.

As in an example shown in FIG. 5, when it is assumed that each reference vertex is a sphere with a size of radius r, a target point on a three-dimensional space may also be considered as a sphere with a size of radius r. In other words, through a spherical harmonic function coefficient, spherical directional color information for a target vertex may be derived.

On a three-dimensional grid composed of a plurality of voxels, configuring a radiance field based on ray tracing has an advantage in terms of three-dimensional scene representation quality. However, configuring a radiance field based on ray tracing has a problem that a large amount of data must be used.

In order to synthesize a viewport image at a target virtual position, a ray projected onto a corresponding image determines the color value of a pixel in a viewport image. Specifically, when a ray is projected onto a viewport image, the color value of a pixel in a viewport image may be determined by aggregating the color values of a plurality of reference voxels through which a ray passes.

When there are lots of reference voxels, it means that a large amount of information is used to determine the color value of a pixel in a viewport image. Meanwhile, the larger the amount of information, the better the reproduction/reconstruction quality will be, but a large amount of information is a disadvantage in a structure that requires data compression and transmission, such as a server-client structure.

As in an example shown in FIG. 11, a three-dimensional volumetric space may be represented in the form of a three-dimensional grid structure, and the form of a three-dimensional grid structure may be represented in multi-layered planes. A multi-layered plane structure may be called Multi-layered Plane Images (MPI).

Based on a ray tracing-based algorithm, when a three-dimensional volumetric space is represented in a multi-layered plane structure, not only the surface of a target background, but also voxels configuring the inside of a three-dimensional volumetric space, not the surface of a background, have a valid value. It increases the number of valid pixels that must be packed into an atlas, hereby causing a problem in which the amount of data that must be encoded/decoded is increased.

In order to solve the problem, placing voxels capable of representing directional information (i.e., spherical harmonics) only on the texture surface of a background configuring a target scene may be considered.

FIG. 13 shows an example in which a voxel is positioned on an object surface.

Basically, a coordinate on the surface of a background may be determined by referring to a depth image generated through an image processing technique (e.g., depth estimation technique).

Let's assume that an object 1301 is cut into two based on a central surface 1302. When a cut surface is viewed from the top, the clustering form of voxels 1310 located on an object surface may be the same as in an example shown on the right of FIG. 13.

In order to represent voxels located on an object surface in a multi-layered plane structure, voxels that exist consecutively between planes configuring a multi-layer structure must also be able to be represented. In the existing multi-layered plane structure, planes are spaced apart from each other, so in order to reduce an interval between planes, the number of planes must be increased. However, increasing the number of planes increases data that must be encoded/decoded (e.g., the number of patches), and accordingly, a problem occurs in which compression efficiency is reduced.

In order to solve the problem, a method for adding a lower layer between basic layers may be considered.

Meanwhile, when spherical harmonics coefficients are projected onto a plurality of images, it means that the coefficient of spherical harmonics for one voxel is projected onto a plurality of images. In other words, a plurality of images may be considered to represent the same spatial position.

In this case, each of a plurality of images may be defined as a basic layer. In this case, a lower layer may represent a spatial position between images in which a coefficient in specific order is packed (e.g., images in which SH[0] is packed).

Alternatively, a set of a plurality of images (i.e., image data of a plurality of channels) may be defined as a basic layer.

In other words, a lower layer may represent a spatial position between a basic layer onto which voxels spaced apart by the first position are projected and a basic layer onto which voxels spaced apart by the second position are projected.

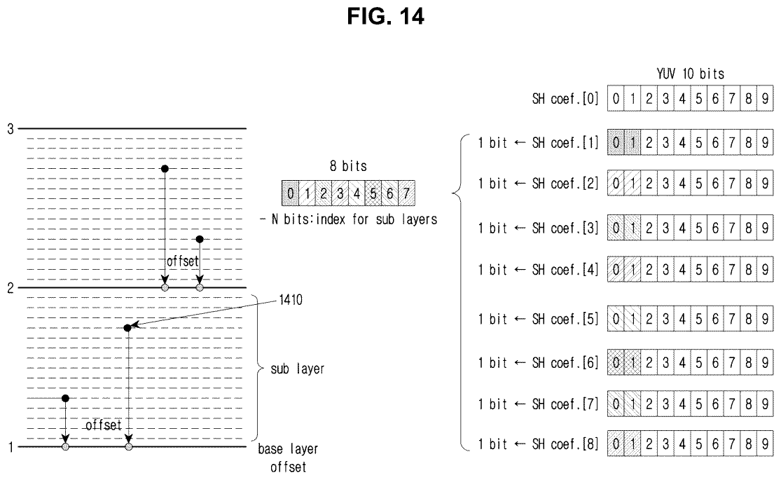

FIG. 14 shows a structure in which lower layers are added between basic layers.

Specifically, FIG. 14 relates to the expansion of three layers under a multi-layered plane structure.

Generally, the position of a voxel on a three-dimensional space may be represented based on a three-dimensional position coordinate. However, when a three-dimensional space is represented in a multi-layered plane structure, all voxels are located in a basic layer. Accordingly, the position of a voxel may be determined based on the index information of a basic layer to which a corresponding voxel belongs, a coordinate within a basic layer and depth information corresponding to the coordinate.

However, as in an example shown in FIG. 14, when lower layers (i.e., sub-layers) are added, a problem may occur in representing the position of voxels that do not belong to a basic layer (i.e., voxels belonging to a lower layer). In other words, a problem may occur in which the position information of specific voxels is not accurately represented only with a basic layer, which may be solved by introducing lower layers that may represent more detailed position information than a basic layer. In other words, lower layers may be introduced to increase the resolution of a three-dimensional space. Here, a lower layer means a layer having offset information that may specify the position of a specific voxel, and offset information may represent a distance from a basic layer.

In order to solve the problem, the present disclosure proposes using a voxel having directional information, not a general voxel. Here, directional information represents spherical harmonics (specifically, spherical harmonics coefficients). As an example, when the order of spherical harmonics is 2, one voxel is composed of 9 spherical harmonics coefficients, and in order to represent 9 spherical harmonics coefficients, 9 general pixels are used. In other words, the texture color information of a voxel located in a three-dimensional space may be obtained based on pixels in 9 images having the same coordinate (i.e., the same x-axis and γ-axis coordinates) as a corresponding voxel.

9 pixels are used to represent the texture information of a voxel, and in this case, when the z-axis information of a voxel is embedded in some bit(s), the position of a voxel located between basic layers may be specified.

When a current voxel 1410 exists between basic layers, the position of a current voxel 1410 may be specified based on a basic layer that is already located and offset information, which is a distance from a basic layer.

When it is assumed that each layer of a multi-layered plane structure is 10 bits (YUV 10 bits), 9 pixels of a 10-bit standard are used to represent the texture information of a current voxel 1410. In this case, 8 of 9 general pixels may be selected, and N bits may be collected from each of the 8 selected pixels to represent 8-bit offset information. N may be an integer such as 1, 2, 3 or 4, etc.

In this case, considering an error due to noise generation through a video compression process, each bit of offset information may be represented in more than 1 bit. Hereinafter, it is assumed that N is 2.

Meanwhile, an index allocated to lower layers may be determined according to a distance from a basic layer. In other words, offset information may indicate the index of a lower layer.

As an example, FIG. 14 shows an example in which 8-bit offset information is represented by collecting each 2-bits from 8 bits for 8 coefficients excluding the 0-th coefficient. The 2-bits of each pixel represent 0 and 1. For example, when the value of 2-bits extracted from a spherical harmonics coefficient is 0 or 1, it may be determined that it represents 0 of a bit for representing offset information, and when the value of 2-bits extracted from a spherical harmonics coefficient is 2 or 3, it may be determined that it represents 1 of a bit for representing offset information.

However, as the number of bits required to represent offset information increases, the number of bits for representing a spherical harmonics coefficient decreases, which may reduce color information representation. Accordingly, the number of bits for representing offset information may be appropriately determined according to application.

It must be noted in the embodiment that the offset information of a voxel is included in some bits of pixels, but color information represented by a voxel is stored only in a basic layer. In other words, there is a difference in that a basic layer is an existing layer that holds voxel information, but a lower layer is an abstract layer that is located by offset information packed into some of the bits expressing a voxel.

In this way, allocating offset information to some of the bits representing a voxel may be called a ‘bit packing’ method. In addition, a bit string generated by separating some bits of a plurality of pixels to include information other than the color information of a voxel may be called a collected bit string. As an example, in an example shown in FIG. 14, it was illustrated that 2 bits are separated from 8 pixels to generate a collected bit string of a 8-bit length.

Through bit packing, a voxel at an arbitrary position in a three-dimensional space, not a three-dimensional grid structure, may be represented. In this case, in order to represent it in a multi-layer image, a process of projecting the color information of a voxel onto a basic layer may be required.

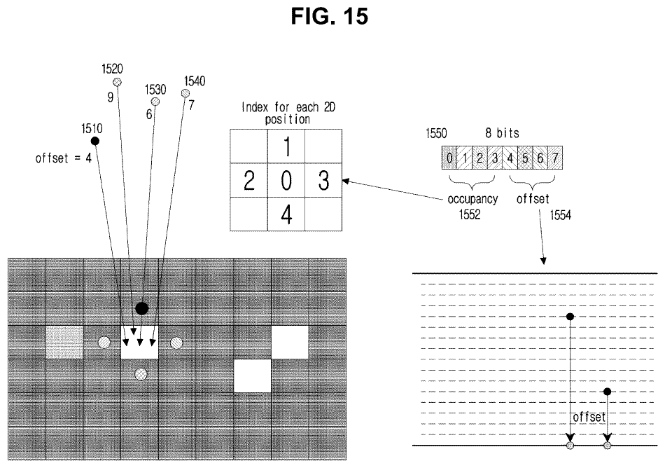

FIG. 15 shows an example in which color information of a voxel is projected onto a basic layer.

Unlike the cluster of pixels in a two-dimensional image, when voxels existing at an arbitrary position on a three-dimensional space are projected onto a two-dimensional plane, as in an example shown in FIG. 15, a plurality of voxels may be projected onto the same two-dimensional position.

In this case, a voxel projected first may be set to occupy a corresponding position, and a voxel that may not be allocated to a corresponding position by a voxel projected first may be allocated to an empty pixel among the adjacent pixels.

As an example, as in an example shown in FIG. 15, it is assumed that the first voxel to the fourth voxel 1510, 1520, 1530 and 1540 are projected onto the same coordinate on a 2D plane. In addition, it is assumed that the offset of each of the first voxel to the fourth voxel is 4, 9, 6 and 7.

When it is assumed that voxels are projected onto a 2D plane in ascending order of distance (i.e., offset) from a basic layer, a projection coordinate for a 2D plane may be determined in the order of the first voxel 1510, the third voxel 1530, the fourth voxel 1540 and the second voxel 1520. When a position onto which a voxel will be projected is empty, the position may be set as the projection coordinate of a corresponding voxel. On the other hand, when a position onto which a voxel will be projected is not empty, a position adjacent to the position may be set as the projection coordinate of a corresponding voxel.

Meanwhile, when a coordinate onto which a voxel is projected is determined as an adjacent coordinate other than an original coordinate, the original coordinate of a corresponding voxel may be reconstructed in a decoding process only when original coordinate information is known.

To this end, some bits of the collected bit string may be used to indicate whether to assign an adjacent position. As an example, in an example shown in FIG. 15, it was illustrated that 4 bits 1554 of the collected bit string 1550 are used to include offset information and the remaining 4 bits 1552 are used to include occupancy information (i.e., index information).

As an example, as in an example shown in FIG. 15, index 0 may be allocated to the original position of a voxel, and indexes 1 to 4 may be allocated to the adjacent positions of an original position. When a voxel is assigned to an original position, a value of index 0 may be encoded/decoded for a corresponding voxel. On the other hand, when a voxel is assigned to the adjacent position of an original position, an index value greater than 0 (e.g., indexes 1 to 4) may be encoded/decoded for a corresponding voxel.

As an example, in an example shown in FIG. 15, the first voxel 1510 is allocated to a 2D plane first, so the index of the first voxel 1510 is set as 0. On the other hand, since the projection position of the second voxel to the fourth voxel is the same as the projection position of the first voxel 1510, an index having a value greater than index 0 (i.e., any one of the indexes 1 to 4) may be allocated to each of the second voxel to the fourth voxel. As an example, when the second voxel 1520 is allocated to the top adjacent position of an original position, the index of the second voxel 1520 may be set as 1.

Meanwhile, in a shown example, it was illustrated that a voxel may be allocated to top, bottom, left and right positions based on the center position. However, according to the application or encoding/decoding settings, the number of adjacent pixels may increase or decrease.

Alternatively, a voxel may be assigned to the empty place of the next basic layer, not a current basic layer, and an index may be allocated to the empty place of the next basic layer.

When the method is followed, the number of voxels that are lost due to being projected onto the same coordinate may be minimized.

In general, when a voxel in the form of a point cloud is projected onto a two-dimensional image, projection positions are likely to be distributed in a scattered manner. However, as in an example above, points projected onto a 2D image may form a cluster by assigning occluded voxels to an original position and an adjacent position.

Although voxels are projected onto a 2D plane, when the distribution of projected vertices is scattered, there is a high possibility that corresponding vertices will be lost during a compression process. Specifically, when vertices are sparsely distributed on a 2D plane, there is a high possibility that corresponding vertices will be classified as high-frequency components during a video compression process. Accordingly, there is a high possibility that corresponding vertices will be attenuated/lost through a low-pass filter, etc.

Accordingly, in order to improve video compression quality, a post-processing algorithm that connects pixels close to each other or fills a pixel judged as a hole may be applied.

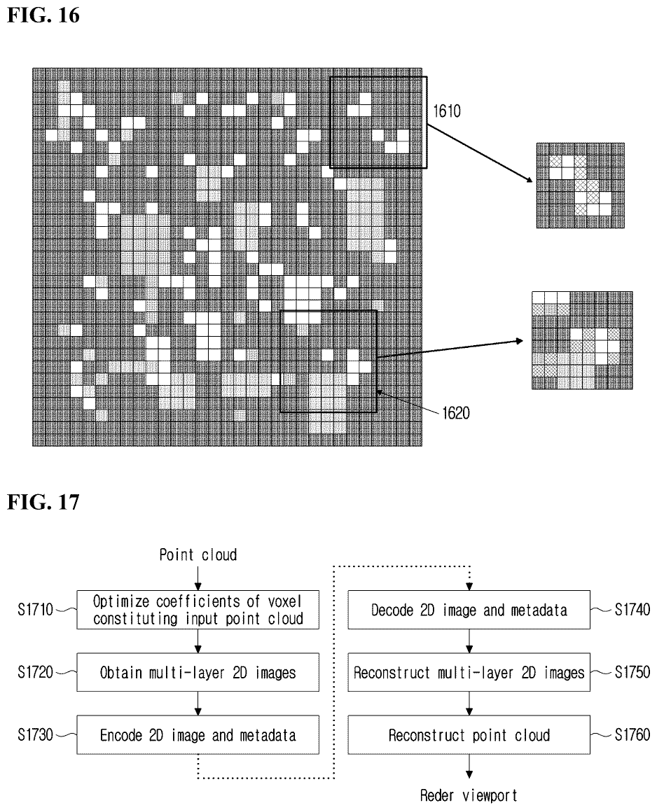

FIG. 16 is a diagram for describing an example in which a post-processing algorithm is applied.

The cluster of pixels may be treated as a single patch. In FIG. 16, drawing signs 1610 and 1620 illustrated an example in which projected pixels form a small cluster and a small cluster is dilated to adjacent pixels to derive a larger patch. In other words, it was illustrated that a larger patch is derived by combining an existing patch and a dilated small cluster.

Meanwhile, pixels padded through a hole filling or dilation process are not valid, so they must not be used in a rendering process. In other words, in order to determine pixels that are additionally generated by performing padding as an invalid pixel, flag information for distinguishing valid pixels from invalid pixels may be encoded and signaled.

In this case, flag information may be embedded in a collected bit string. As an example, some bits of the collected bit string may be allocated for flag information. Alternatively, flag information indicating that a corresponding pixel is valid or invalid may be represented through a combination of bits allocated for occupancy information and offset information.

In other words, in a collected bit string, at least one of offset information, occupancy information or flag information may be included and transmitted.

Meanwhile, at least one of the length of a collected bit string, the number of bits allocated for offset information in a collected bit string, the number of bits allocated for occupancy information or the number of bits allocated for flag information may not be a fixed value, but may be a value that is changed according to an application or a user request.

As an example, in FIG. 14, it was illustrated that the most significant bit (MSB) 2-bit of each pixel is used to represent 1 bit of the collected bit string. On the other hand, a collected bit string may be composed of the least significant bit (LSB) 2-bit, which is more sensitive to noise.

In order to encode/decode a three-dimensional spatial image according to the above-described method, the following information also needs to be additionally encoded/decoded.

First, at least one of the number of basic layers for representing voxels distributed in a three-dimensional grid structure on a three-dimensional space, the number of lower layers that are a unit for representing the position of voxels that may not be specified by a basic layer or the index information of a lower layer required to indicate a distance spaced apart from a basic layer may be encoded/decoded.

Here, the number of lower layers may be related to the number of coefficients of spherical harmonics used to represent the directional information of a voxel.

At least one of the number of pixels used to configure a collected bit string (e.g., 8 in FIG. 14), the number of bits extracted from each pixel to configure a collected bit string (e.g., 2 in FIG. 14), the number of bits allocated for offset information in a collected bit string, the number of bits allocated for occupancy information or the number of bits allocated for flag information may be encoded and signaled.

Table 1 shows a syntax structure that dilates the MPI profile of a MIV standard, which is configured to include information listed above.

TABLE 1

| | De- |
|---|---|
| | scrip- |
| | tor |
| asps_miv_2_extension( ) { | |
| asme_patch_margin_enabled_flag | u(1) |
| asme_mpi_auxiliary_layer_enable_flag | u(1) |
| if(asme_mpi_auxiliary_layer_enable_flag) { | |
| asme_num_mpi_layers_minus1 | u(16) |
| asme_num_sub_layers _minus1 | u(16) |
| asme_num_sub_layering_bits | u(16) |
| asme_ num_sub_layering_offset_bits | u(16) |
| asme_num_occupancy_flag_bits | u(16) |
| asme_volumetric_rendering_flag // otherwise DIBR | u(1) |
| } | |
| asme_reserved_zero_8bits | u(8) |
| } | |

In Table 1 above, a syntax asme_mpi_auxiliary_layer_enable_flag may indicate whether a dilation is applied to additionally configure a lower layer other than a basic layer on an existing MPI profile.

A syntax asme_num_mpi_layers_minus1 may represent the number of basic layers (i.e., MPI layers).

A syntax asme_num_sub_layers_minus1 may represent the number of layers that are additionally dilated for each basic layer (i.e., lower layers).

A syntax asme_num_sub_layering_bits may represent the number of bits used to represent the index of layers that are additionally dilated for each basic layer. In other words, a collected bit string may be configured by separating as many bits as indicated by asme_num_sub_layering_bits from a pixel belonging to the remaining basic layers excluding a basic layer including the first spherical harmonics coefficient.

A syntax asme_num_sub_layering_offset_bits may represent the number of bits used to represent offset information (i.e., the index of a lower layer) in a collected bit string.

A syntax asme_num_occupancy_flag_bits may represent the number of bits used to represent occupancy information in a collected bit string. Here, occupancy information may include information indicating an offset with an original coordinate due to occlusion that occurred during a projection process or whether a pixel at a corresponding position is a valid pixel.

A syntax asme_volumetric_rendering_flag may indicate a rendering method in a decoder based on a dilated layer structure (i.e., a structure in which lower layers are added to basic layers). As an example, a rendering method may include at least one of a general volumetric rendering technique using spherical harmonics, a plenoxel-based rendering method or a rendering method using 3D gaussian splatting.

Table 2 illustrates a patch data unit-related syntax structure.

TABLE 2

| | Descriptor |
|---|---|
| pdu_miv_extension( tileID, p ) { | |
| if( asme_max_entity_id > 0 ) | |
| pdu_entity_id[ tileID ][ p ] | u(v) |
| if( asme_depth_occ_threshold_flag ) | |
| pdu_depth_occ_threshold[ tileID ][ p ] | u(v) |
| if( asme_patch_texture_offset_enabled_flag ) | |
| for( c = 0; c < 3; c++ ) | |
| pdu_texture_offset[ tileID ][ p ][ c ] | u(v) |
| if( asme_inpaint_enabled_flag ) | |
| pdu_inpaint_flag[ tileID ][ p ] | u(1) |
| if( asme_patch_margin_enabled_flag ) { | |
| pdu_2d_margin_u[ tileID ][ p ] | u(v) |
| pdu_2d_margin_v[ tileID ][ p ] | u(v) |
| } | |
| if( asme_mpi_auxiliary_layer_enable_flag) { | |
| pdu_sub_layer_id | u(16) |
| } | |
| } | |

In Table 2, a syntax pdu sub_layer_id may indicate the identifier (or index) of a lower layer to which a current patch belongs.

Meanwhile, among the rendering methods, plenoxel-based rendering method may be implemented by dilating lower layers by the number of coefficients of spherical harmonics to a basic layer through a syntax asme_volumetric_rendering_flag.

In order to implement a 3D Gaussian splatting method among the rendering methods, a plurality of corresponding points may be searched based on camera calibration information and a multi-view reference image that captures a target three-dimensional volumetric space. Afterwards, searched corresponding points are used as the initial position value of a point cloud, and densification and splitting are repeatedly performed from an initial point cloud to determine the position of points that may optimally render a target three-dimensional space. In addition, a parameter configuring an ellipsoid shape that may be represented by a determined point may be searched through the gradient descent. In this case, in order to configure an ellipsoid shape, the size information of an ellipsoid (e.g., radius information for each of the x, y, and z axes) and the rotation information of an ellipsoid (e.g., rotation information for each of the x, y, and z axes) may be required. In addition, the coefficients of spherical harmonics for color information that may be represented by each ellipsoid for each direction may be required.

In order to use a method proposed in the above-described embodiments, the three-dimensional coordinates of each point in a three-dimensional space and color information possessed by each point may be encoded/decoded. In addition, for 3D Gaussian splatting, the size information and rotation information of an ellipsoid (or a sphere) may also be additionally encoded/decoded.

Table 3 illustrates a syntax structure including the information.

TABLE 3

| | De- |
|---|---|
| | scrip- |
| | tor |
| asps_miv_2_extension( ) { | |
| asme_patch_margin_enabled_flag | u(1) |
| asme_mpi_auxiliary_layer_enable_flag | u(1) |
| if(asme_mpi_auxiliary_layer_enable_flag) { | |
| asme_num_mpi_layers_minus1 | u(16) |
| asme_num_sub_layers _minus1 | u(16) |
| asme_num_sub_layering_bits | u(16) |
| asme_ num_sub_layering_offset_bits | u(16) |
| asme_num_offset_embedding_bits | u(16) |
| asme_num_occupancy_flag_bits | u(16) |
| asme_voxel_sampling_rate | u(16) |
| asme_volumetric_rendering_flag // otherwise DIBR | u(1) |
| } | |
| asme_reserved_zero_8bits | u(8) |
| } | |

In an atlas sequence parameter, a syntax asme_num_offset_embedding_bits indicates the number of bits (i.e., the length of a collocated bit string) used to represent the offset of a lower layer (i.e., the index of a lower layer). As an example, when an embodiment according to FIG. 14 is applied, a syntax asme_num_offset_embedding_bits may indicate 8, and when an embodiment according to FIG. 15 is applied, a syntax asme_num_offset_embedding_bits may indicate 4.

Through sub-sampling, only some of the voxels in a three-dimensional space may be projected onto a two-dimensional plane. In this case, a syntax asme_voxel_sampling_rate indicating a sampling rate for the cluster of voxels may be encoded/decoded. As an example, when the value of a syntax asme_voxel_sampling_rate is 2, it represents that ½ sampling is applied to each of the horizontal and vertical directions. Through sampling, the number of valid pixels projected onto a two-dimensional plane may be reduced, and accordingly, the amount of encoded/decoded data may be reduced.

Meanwhile, since a distance between voxels may vary depending on a sampling rate, a sampling rate may be notified to a receiving terminal through a syntax asme_voxel_sampling_rate. A receiving terminal may calculate a distance between voxels based on the syntax and perform rendering on a view image by referring thereto.

FIG. 17 is a flow chart of an image encoding method and an image decoding method according to an embodiment of the present disclosure.

Based on a texture image and a depth image, a point cloud configuring a three-dimensional scene may be generated.

An encoder may arrange voxels based on an input point cloud and perform optimization for the coefficient of each voxel based on a texture image and a depth image S1710. Meanwhile, the optimization of a voxel coefficient may be based on plenoxel or 3D Gaussian splatting.

Here, a voxel coefficient may represent the coefficient of spherical harmonics or a feature vector generated by a deep learning algorithm.

When a voxel coefficient is optimized, voxels located in a three-dimensional space may be projected onto a two-dimensional plane to obtain a two-dimensional image S1720. A two-dimensional image may be an image that integrates multiple image patches (i.e., an atlas).

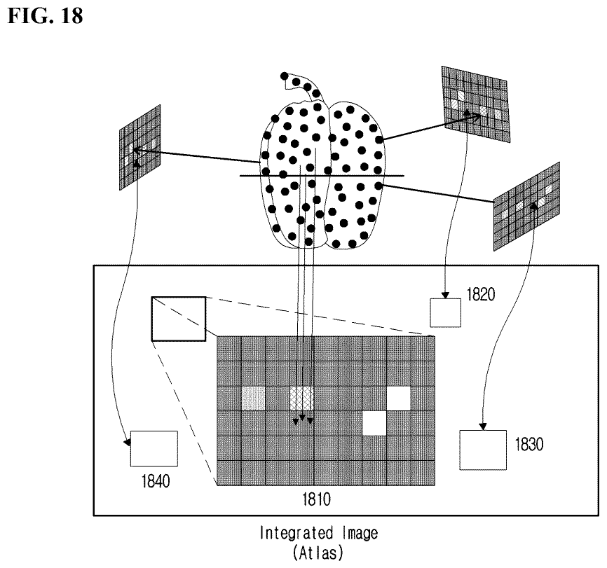

FIG. 18 shows an example in which a two-dimensional image is generated.

In order to obtain a 2D image from voxels representing a target object, a voxel must be projected onto a 2D plane. When geometric information between a voxel on a 3D space and 2D images is known, a voxel on a 3D space may be reconstructed from a 2D image through unprojection.

As described above, when voxels representing an object are projected onto a 2D plane, a plurality of voxels may be projected onto the same position (i.e., the same coordinate). In this case, only one voxel is projected onto a corresponding position and the remaining voxels are lost. In order to avoid this problem, 3D voxels may be projected onto a plurality of 2D planes with a different view.

As an example, in an example shown in FIG. 18, it is illustrated that voxels on a 3D space are projected onto four 2D planes. In other words, it is illustrated that a multi-layer 2D image having four layers is obtained.

2D images onto which 3D voxels are projected may be converted into an integrated image with a higher resolution.

In FIG. 18, an example is shown in which four 2D images (1810, 1820, 1830, and 1840) are configured as a part of an integrated image.

Meanwhile, the number of integrated images may be plural.

A patch may be extracted from each of the 2D images, and extracted patches may be packed to generate an integrated image. Here, a patch may represent the cluster of vertices in a 2D image. In this case, geometric information may be encoded/decoded as metadata in a 2D image unit or a patch unit so that forward and backward transforms between a 2D image and an integrated image may be performed.

Afterwards, a 2D image and metadata therefor may be encoded S1730.

In a decoder, a received 2D image and metadata may be decoded S1740. In a decoder, based on decoded metadata, multi-layer 2D images may be reconstructed from a 2D image S1750.

Afterwards, a point cloud may be reconfigured by using metadata for a patch and voxel information (i.e., position information onto which a voxel is projected) recorded in a multi-layer 2D image S1760.

Afterwards, based on a reconstructed point cloud, a viewport image (i.e., a viewport image) may be rendered.

Meanwhile, in an example shown in FIG. 17, it is illustrated that voxel coefficient optimization S1710 is performed on an initial point cloud. However, while encoding voxel information, some voxels or coefficient information of a voxel may be lost. Accordingly, a method for compensating for loss caused during an encoding process needs to be considered.

Meanwhile, an image generated by integrating a plurality of patch images includes voxel information (e.g., spherical harmonics coefficient information) as image information. However, basically, an integrated image is a two-dimensional array data structure for storing a three-dimensional point cloud. Considering this, it is necessary to replace the coefficient information of a voxel in an integrated image with data considering loss in an encoding process.

To this end, when an integrated image is encoded, an encoder may decode an integrated image by using metadata and reconstruct three-dimensional voxels (i.e., point clouds) from a decoded integrated image. Afterwards, the coefficient information of a voxel is re-trained for a reconstructed point cloud. In this case, for integrity of voxel position information derived from the first encoding process, the position of a voxel may be fixed, and only the coefficient information of a voxel may be trained.

Afterwards, an encoder may replace the trained coefficient information of a voxel with the coefficient information of a voxel stored in an integrated image. The coefficient information of a voxel trained for a reconstructed point cloud may be used to compensate for loss occurring in an encoding process after the first optimization.

Meanwhile, voxel coefficient optimization refers to a process in which three-dimensional warping is performed on voxels with reference view images based on the coordinates of a three-dimensional point cloud, and a value with the minimum cost function is derived by comparing a warped value with a ground truth. In this case, the gradient descent may be used to derive a value that minimizes the cost function.

As mentioned, generally, voxel coefficient optimization may be performed based on a three-dimensional point cloud coordinate. However, information loss may occur as a three-dimensional point cloud is projected onto a two-dimensional plane. A projection error as above may act as an element that deteriorates reconstruction quality when reconstructing a voxel projected onto a two-dimensional image into a three-dimensional point cloud.

Accordingly, voxel coefficient optimization may also be performed based on a two-dimensional projection coordinate instead of a three-dimensional point cloud coordinate. The coordinate of a three-dimensional point cloud may be used only in an intermediate transform process. Through this, optimal voxel coefficient information learning or training may be performed by considering a projection error.

Meanwhile, when reference vertices are assumed as a sphere with a radius of r, directional information (i.e., the coefficient of spherical harmonics) for a three-dimensional sphere located on a target three-dimensional space may be allocated.

In the embodiment shown in FIG. 5, it was assumed that size information on the size of all vertices (i.e., radius r) was the same. However, in the process of studying a target three-dimensional scene, the sizes of vertices may be changed.

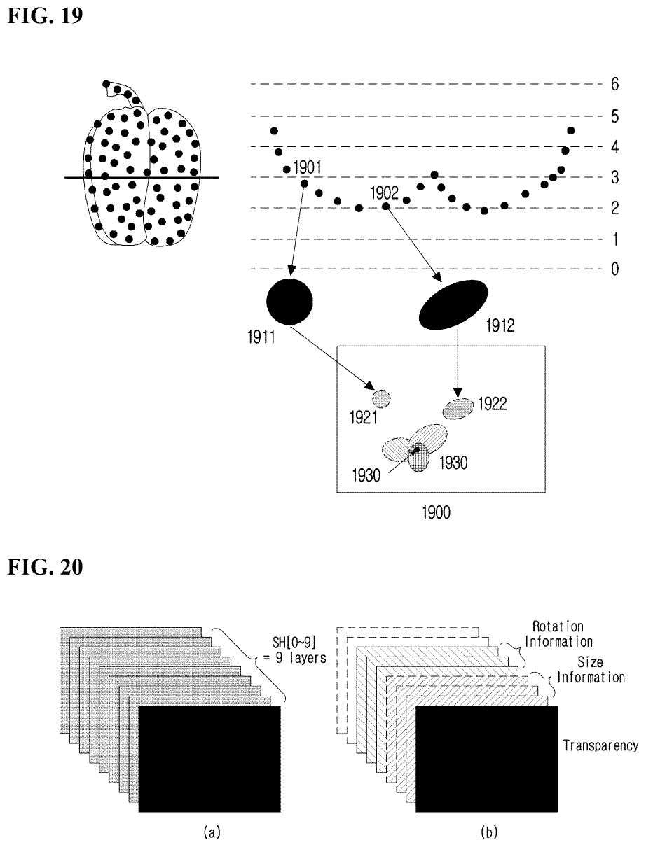

FIG. 19 represents a process in which the color information of a vertex is rasterized into a viewport image when the sizes of vertices positioned on a three-dimensional space is different from each other.

In a process in which vertices are projected onto a target viewpoint image and synthesized, the color information of a vertex may be rasterized into a target viewpoint image.

Specifically, in FIG. 19, it was illustrated that a first vertex 1901 is a sphere 1911 with a radius of r. On the other hand, it was illustrated that a second vertex 1902 is an ellipsoid that the radius for each of a x-axis, a y-axis, and a z-axis is set individually.

A three-dimensional sphere 1911 may be modeled through color information (e.g., a spherical harmonic function coefficient) and size information for each direction held by a first vertex 1901. Similarly, a second vertex 1902 may be modeled as an ellipsoid 1919 through color information and size information for each direction held by a second vertex 1902. Meanwhile, for an ellipsoid, not only size information for each axis, but also rotation information for each axis may be set. Accordingly, an ellipsoid may be modeled so that each axis faces a different direction (orientation).

A sphere 1911 and an ellipsoid 1919 geometrically model the probability distribution within the three-dimensional shape (e.g., within a range set by a radius of r) of directional color intensity information (e.g., a spherical harmonic function coefficient) corresponding to each direction (azimuth) based on the center of a three-dimensional shape.

When the probability distribution follows Gaussian distribution, the distribution of a corresponding structure may be defined by Equation 9 below.

$$G ( x ) = {e}^{- \frac{1}{2} {( x )}^{{T}_{\sum } - 1} ( x )} \qquad [ Equation 9 ]$$

In Equation 9 above, 2 represents a three-dimensional covariance matrix for Gaussian distribution in a three-dimensional shape.

When a three-dimensional Gaussian, such as a sphere 1911 and an ellipsoid 1919, is projected onto the target viewport image 1900, it is rasterized to form a two-dimensional circular shape 1921 and a two-dimensional elliptical shape 1922, respectively.

In other words, the color intensity information of a ray radiating from the center of a three-dimensional shape is modeled into a three-dimensional Gaussian such as a sphere 1911 or an ellipsoid 1919 according to the Gaussian probability distribution with reference to size information and rotation information. In addition, when a three-dimensional Gaussian is projected onto a target two-dimensional image 1900, it may be rasterized into a two-dimensional circle or a two-dimensional ellipse, and a target viewpoint image may be synthesized.

When a different Gaussian is projected onto the same pixel position, the value of a pixel within a corresponding overlapping region 1930 may be derived through a weighted sum operation using the occupancy information (or opacity) of Gaussians primitives projected onto the same position as a weight.

$${\sum }^{′} = JW \sum {W}^{T} {J}^{T} \qquad [ Equation 10 ]$$

Equation 10 above shows a process in which a covariance matrix Σ′ in a camera coordinate system is calculated when a viewing transformation matrix W is given. Equation 10 is used when a three-dimensional Gaussian is projected onto a two-dimensional image.

J means a Jacobian matrix that affine approximation is performed for perspective transformation. A 2×2 variance matrix may be derived from a matrix Σ′.

In Equation 10, Σ is a three-dimensional covariance matrix, and when a scaling matrix and a rotation matrix are given, it may be derived through the following Equation 11.

$$\sum = {RSS}^{T} {R}^{T} \qquad [ Equation 11 ]$$

In Equation 11, a scaling matrix may be expressed by a three-dimensional vector and a rotation matrix may be expressed by a quaternion.

When modeling the Gaussian probability distribution of a light source radiating toward the center of a three-dimensional shape through equations described, an attribute such as directional color (intensity) information, scaling information, and/or rotation information may be required.

Here, directional color (intensity) information may be represented using a spherical harmonic function coefficient. Directional color (intensity) information may be represented in a vector format, or a hash code or may be expressed in a feature vector or a matrix format that configures a Multi-Layer Perceptron (MLP) neural network learned by a deep learning-based algorithm.

Scaling information and/or rotation information may also have a matrix form, a feature vector, or an MLP neural network matrix form.

Alternatively, as described above through FIG. 12, attribute information may be represented in a layer form. As an example, directional color (intensity) information may be encoded/decoded as multi-layer images corresponding to a texture component, and size information and rotation information may be encoded/decoded as multi-layer images corresponding to a transparency component.

FIG. 20 shows an example in which attribute information is composed of multi-layer images.

FIG. 20(a) shows an example in which directional color (intensity) information is represented with a plurality of texture images.

FIG. 20(b) shows a plurality of transparency component images. The first layer among a plurality of transparency component images may represent transparency for a corresponding texture image. From the second layer, size information and rotation information may be sequentially allocated.

Meanwhile, information about the arrangement order of information may be encoded and signaled. On a decoder side, the information may be decoded to reconstruct each information.

Directional color (intensity) information, size information, rotation information, and occupancy information may be derived through gradient descent. Specifically, through gradient descent, the optimal value of each parameter may be derived by finding a point where a cost function with a training data set for each parameter is minimized. Equation 10 below illustrates a cost function that combines L1 loss and a Depth Structural Similarity Index (D-SSIM) evaluation index.

$$ℒ = ( 1 - λ ) {ℒ}_{1} + {λℒ}_{D - SSIM} \qquad [ Equation 12 ]$$

In Equation 12 above, variable A may be used for weighting or preventing overfitting during a learning process. The value of variable A may be arbitrarily adjusted.

Meanwhile, when directional color information, size information, rotation information, and occupancy information are converted into a two-dimensional image, the valid data range of each parameter may be determined, and normalization of each parameter may be performed based on the minimum value and the maximum value of a valid data range. Accordingly, a 2D image may include a normalized value.

Meanwhile, a decoder may decode a 2D image and perform denormalization on a decoded value. In order to perform denormalization in a decoder, valid data information for each parameter, e.g., information about the minimum value and the maximum value, may be encoded and signaled as metadata.

Meanwhile, as shown in an example in FIG. 10, when the order of spherical harmonics is 0, the first coefficient of spherical harmonics holds color information that is uniformly applied to all directions. When the order of spherical harmonics increases, color information for a specific direction, i.e., color information intensity corresponding to a high-frequency component, may be represented.

Meanwhile, a general image is composed of three channels (e.g., R, G, B). Accordingly, in order to represent color information of a vertex, directional color intensity information for three channels is required.

Accordingly, a texture image (e.g., each layer shown in FIG. 20(a)) representing directional color information may be composed of three channels. In other words, since one texture image (i.e., one layer) is composed of three channels, the number of channels of a multi-layer image may be three times the number of coefficients of spherical harmonics.

In order to encode/decode the image of an MPI structure through a general video codec, the images of an MPI structure may be converted to a YUV standard. In this case, when the image of an MPI structure is converted to a YUV standard, each layer is composed of three sub-channels. Meanwhile, when a chroma subsampling rate is 4:2:2 or 4:2:0, not 4:4:4, sampling conversion for a UV component may be performed.

According to a chroma subsampling rate, the size of a U channel and a V channel may be different. As the size of a U channel and a V channel increases, a bitrate may increase.

Meanwhile, under a YUV standard, a Y component represents brightness information, and an U component and a V component represent color information. In this case, an U component represents a difference between blue information and brightness information (i.e., U=B−Y), and a V component represents a difference between red information and brightness information (i.e., V=R−Y).

According to a chroma subsampling rate, brightness information may be encoded/decoded with high resolution, and color information (i.e., U and V) may be encoded/decoded with low resolution. The coefficient of spherical harmonics may also be encoded/decoded in a similar manner.

Specifically, in FIG. 20(a), the first layer (i.e., the first texture image) is represented by three channels (e.g., YUV 444, YUV 422, or YUV420). Here, the first layer may represent the coefficient of spherical harmonics whose order is 0.

For a layer to which the coefficient of spherical harmonics in subsequent order is allocated (i.e., the remaining layers excluding the first layer), only the brightness component of a spherical harmonics coefficient may be represented. In other words, representation for the color component of a spherical harmonics coefficient may be omitted. In other words, for the remaining layers excluding the first layer, encoding/decoding for a color component may be omitted, and accordingly, a bitrate may be reduced.

As described above, a Y component represents brightness information, and U and V components represent a difference between color information and brightness information. For spherical harmonics coefficients whose order is greater than 0, only brightness information is encoded/decoded and the encoding/decoding of color information is omitted, so color information per direction may be approximated based on brightness information per direction (i.e., spherical harmonics coefficient information included in a Y channel).

In other words, based on a YUV color space, in encoding/decoding directional color information (i.e., a spherical harmonics coefficient), for the coefficient of spherical harmonics corresponding to the 0-th order, all coefficients may be encoded/decoded for Y, U and V, and for the coefficient of spherical harmonics whose order is greater than 0, only a coefficient corresponding to a Y component may be encoded/decoded.

Meanwhile, through Equations 1 and 2, spherical harmonics for RGB 3 channels may be derived from a RGB image. The spherical harmonics for RGB 3 channels may be converted to YUV 3 channels based on the existing conventional RGB-YUV conversion equation to generate spherical harmonics for YUV 3 channels.

Alternatively, after converting a RGB image into a YUV image, through Equations 1 and 2, spherical harmonics for YUV 3 channels may be derived from a YUV image.

When a YUV standard is used, when a chroma subsampling rate is 4:4:4, color information loss of each vertex (i.e., each Gaussian) may be prevented. Nevertheless, when a chroma subsampling rate is 4:2:2 or 4:2:0, optimization to find the point that minimizes the cost function may be performed using gradient descent based on Equations 1 to 5.

In an optimization process, as an input image uses an image in a YUV 422 or YUV 420 format and training data uses data without color loss (i.e., YUV 444), they may be trained to compensate for loss. In this case, in the process of rendering (i.e., inference) a view image by using a learned parameter, input image format may be required. Accordingly, input image format information may be encoded and signaled as metadata.

As described above, when voxels on a three-dimensional space are projected onto a two-dimensional plane, a situation may arise where a plurality of voxels must be projected onto one coordinate.

In this case, in order to prevent a voxel from being lost during a 2D plane projection process, voxels may be projected onto a plurality of planes with a different central axis.

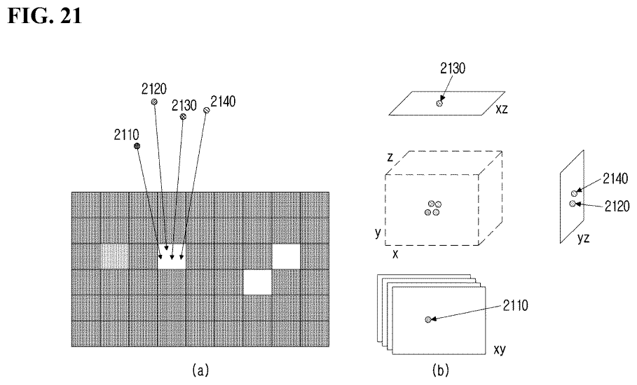

FIG. 21 shows an example in which voxels are projected onto a plurality of planes with a different central axis.

As in an example shown in FIG. 21(a), it is assumed that the first to fourth voxel 2110, 2120, 2130, and 2140 must be projected onto one coordinate on a 2D plane. In this case, the remaining voxels excluding a voxel that is first projected onto a 2D plane are lost to avoid being projected onto a 2D plane.

In order to prevent the problem, a voxel may be projected onto a plurality of 2D planes with a different central axis. As an example, in an example shown in FIG. 21(b), it is illustrated that the first voxel is projected onto a xy plane, the second and fourth voxels are projected onto a yz plane and the third voxel is projected onto a x plane.

As above, when voxels are projected onto a plurality of planes with a different central axis, the number of lost voxels may be reduced. However, as the number of projected planes increases, there is a problem that the number of layers also increases under a MPI structure. As an example, as in an example shown in FIG. 21(b), when three planes with a different central axis are used, the number of layers may increase by up to three times compared to when one plane is used.

When a plurality of planes with a different central axis are used, at least one of the number of central axes, a quantization level for each central axis (i.e., a quantization step applied to layers following a corresponding central axis), or image resolution information for each central axis (i.e., the spatial resolution of layers following a corresponding central axis) may be encoded/decoded as metadata.

However, even when a plurality of planes with a different central axis are used, a voxel may be lost if its projectable coordinate is already occupied by other voxels. In this case, pruning for removing some of the voxels projected to the same coordinate may be performed. Pruning may be performed based on the weight of voxels, and as an example, a weight may represent the occupancy information (i.e., opacity) of a voxel. As an example, pruning for removing at least one voxel may be performed in ascending order of weight among a plurality of voxels.

A three-dimensional scene representation method described in the present disclosure may be performed by projecting a three-dimensional image onto a two-dimensional image based on camera calibration information. In other words, camera calibration information may represent a geometric relationship used in the process of mapping data existing in a high-dimensional space to a low-dimensional space. Accordingly, a three-dimensional scene representation method may be summarized as perspective projection being used based on camera calibration information.

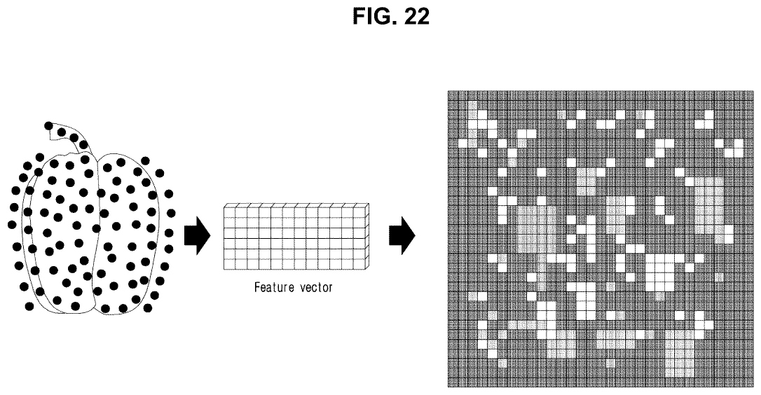

FIG. 22 shows an example in which vertices representing a target scene are packed into a two-dimensional atlas.

Geometric relationship information between point cloud data and a position where each vertex in an atlas is packed may be in the form of a feature vector.

As an example, a feature vector may be coordinate data in an atlas.

As another example, a feature vector may be derived through an optimization method that derives a point with the lowest final loss value in the process of configuring an atlas from input point cloud data based on a predefined cost function. Meanwhile, a point with the lowest final loss value may be derived by using gradient descent.

A cost function may be defined based on a loss rate that occurs in the process of encoding/decoding an atlas.

In other words, a feature vector may represent geometric relationship information that occurs during a dimension reduction (i.e., transform) process. A feature vector may be encoded/decoded as metadata. In a decoder, a feature vector may be used in the process of reconstructing a point cloud from an atlas.

Meanwhile, in FIG. 20, it is illustrated that directional color (intensity) information, size information, rotation information and occupancy information are packed into a different layer. As another example, a plurality of layers may be packed into one atlas by using an atlas generation method shown in FIG. 22.

As an example, when coefficients of nine spherical harmonics are used as directional color (intensity) information, an atlas may be generated by packing nine layers into one column or an atlas may be generated by packing nine layers into a two-dimensional structure (e.g., 3×3).

In this case, the reference point coordinate of the packing information may be indexed through a feature vector.

When one layer includes a plurality of channels (e.g., YUV), a plurality of channels may be merged into one image (i.e., a packed-format image), and then a merged image may be packed into an atlas.

Alternatively, when one layer includes a plurality of channels, a plurality of channels within an atlas may be packed consecutively. As an example, a plurality of channels belonging to the same layer may be packed into one column, or a plurality of channels may be packed into a two-dimensional structure.

The name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. A method of encoding an image, the method comprising:
obtaining two-dimensional images of a multi-layer structure by projecting voxels configuring a point cloud onto a two-dimensional plane; and
encoding the two-dimensional images of the multi-layer structure,
wherein the two-dimensional images include as many texture component images as a number of coefficients of spherical harmonics.

2. The method of claim 1, wherein pixels of a coordinate corresponding to a current voxel in the texture component images (hereinafter, referred to as a corresponding coordinate) include information on the coefficients of the current voxel.

3. The method of claim 2, wherein when a pixel of a coordinate onto which the current voxel is to be projected (hereinafter, referred to as a projection coordinate) is already occupied by another voxel, the corresponding coordinate is a neighboring coordinate of the projection coordinate.

4. The method of claim 1, wherein offset information for representing a position in a three-dimensional space of the current voxel is encoded.

5. The method of claim 4, wherein the offset information indicates an index of a lower layer to which the current voxel belongs among lower layers for a basic layer configuring the multi-layer structure.

6. The method of claim 5, wherein a bit string is configured by separating at least one bit from the pixels corresponding to the current voxel in the texture component images, and
wherein information on the coefficients of the current voxel is represented through remaining bits of the pixels corresponding to the current voxel.

7. The method of claim 6, wherein the bit string is configured by separating a N-bit from each of the pixels,
wherein the N-bit represents 1-bit information of the bit string, and
wherein the N has a value greater than 1.

8. The method of claim 6, wherein the offset information of the current voxel is encoded through the bit string.

9. The method of claim 8, wherein occupancy information of the current voxel is encoded through the bit string.

10. The method of claim 9, wherein the occupancy information indicates whether the corresponding coordinate is equal to a coordinate onto which the current voxel is to be projected.

11. The method of claim 1, wherein the texture component images are classified into a plurality of image groups, and
wherein when a pixel of a coordinate onto which the current voxel is to be projected is already occupied by another voxel in a first image group among the plurality of image groups, the current voxel is projected onto a second image group having a central axis different from the first image group.

12. The method of claim 1, wherein the two-dimensional images further include transparency component images, and
wherein the transparency component images include at least one of transparency information, size information, or rotation information of the voxels.

13. The method of claim 12, wherein the size information represents a radius of each of a x-axis, a y-axis and a z-axis of a voxel, and
wherein the rotation information represents a rotation degree for each of the x-axis, the y-axis and the z-axis of the voxel.

14. The method of claim 12, wherein encoding the two-dimensional images of the multi-layer structure includes:
packing the two-dimensional images into one integrated image; and
encoding the integrated image.

15. A method of decoding an image, the method comprising:
decoding two-dimensional images of a multi-layer structure from a bitstream; and
reconstructing a point cloud from the two-dimensional images,
wherein the two-dimensional images include as many texture component images as a number of coefficients of spherical harmonics.

16. A non-transitory computer-readable recording medium recording an instruction for performing an image encoding method, the image encoding method comprising:
obtaining two-dimensional images of a multi-layer structure by projecting voxels configuring a point cloud onto a two-dimensional plane; and
encoding the two-dimensional images of the multi-layer structure,
wherein the two-dimensional images include as many texture component images as a number of coefficients of the spherical harmonics.
